(19) United States
(12) Patent Application Publication
(10) Pub. No.: US 2026/0039978 A1
(43) Pub. Date: Feb. 5, 2026

(54) SOLID-STATE IMAGING ELEMENT, IMAGING SYSTEM, AND METHOD FOR CONTROLLING SOLID-STATE IMAGING ELEMENT

(71) Applicant: SONY SEMICONDUCTOR SOLUTIONS CORPORATION, KANAGAWA (JP)

(72) Inventor: KUMIKO MAHARA, KANAGAWA (JP)

(21) Appl. No.: 18/997,101

(22) PCT Filed: May 31, 2023
(86) PCT No.: PCT/JP2023/020253

§ 371 Date: Jan. 20, 2025

(30) Foreign Application Priority Data
Jul. 26, 2022 (JP) 2022-118366

(51) Int. Cl. H04N 25/78; H04N 23/611; H04N 25/77; H04N 25/779

(52) U.S. Cl. CPC H04N 25/78; H04N 23/611; H04N 25/77; H04N 25/779

(57) ABSTRACT

Usability of a solid-state imaging element that cuts out a part of an image is improved. A pixel array unit has an array of a plurality of pixels, each of the plurality of pixels being configured to generate an analog signal and sample and hold the analog signal. A vertical scanning circuit drives each of a plurality of rows in the pixel array unit to output a pixel signal. A signal processing circuit reads the pixel signal and performs predetermined signal processing on the pixel signal. A control circuit controls at least one of the vertical scanning circuit or the signal processing circuit to generate compressed data by compressing image data containing an array of the pixel signals, and controls at least one of the vertical scanning circuit or the signal processing circuit on the basis of a result of performing predetermined detection processing on the compressed data to output cutout data, the cutout data corresponding to a predetermined region cut out from the image data.

### TECHNICAL FIELD

The present technology relates to a solid-state imaging element. More specifically, the present technology relates to a solid-state imaging element that detects a predetermined object, an imaging system, and a method for controlling a solid-state imaging element.

### BACKGROUND ART

In the related art, a technology to detect an object such as a face or a person has been used in various fields such as crime prevention and transportation. For example, there has been proposed an imaging device that reads the entire first image to detect a person, and cuts out, from the second image, a region around the person appearing in the first image and analyzes the region to determine whether or not the person has passed through an entrance or the like (see, for example, Patent Document 1).

### CITATION LIST

### Patent Document

PATENT DOCUMENT 1 Japanese Patent Application Laid-Open No. 2020-086961

### SUMMARY OF THE INVENTION

### Problems to be Solved by the Invention

The above-described technology in the related art aims to reduce the processing load of the analysis processing by using a cutout part of the second image. However, if the person moves faster than expected, the person may not appear in the cutout region of the second image. Consequently, there is a possibility that the success rate of the analysis processing for the cutout data decreases, and system usability decreases accordingly.

The present technology has been made in view of such circumstances, and it is therefore an object of the present technology to improve usability of a solid-state imaging element that cuts out a part of an image.

### Solutions to Problems

The present technology has been made to solve the above-described problems, and according to a first aspect of the present technology, provided are a solid-state imaging element including: a pixel array unit having an array of a plurality of pixels, each of the plurality of pixels being configured to generate a pixel signal and sample and hold the pixel signal; a vertical scanning circuit that drives each of a plurality of rows in the pixel array unit to output the pixel signal; a signal processing circuit that reads the pixel signal and performs predetermined signal processing on the pixel signal; and a control circuit that controls at least one of the vertical scanning circuit or the signal processing circuit to generate compressed data by compressing image data containing an array of the pixel signals, and controls at least one of the vertical scanning circuit or the signal processing circuit on the basis of a result of processing the compressed data to output cutout data, the cutout data corresponding to a predetermined region cut out from the image data, and a method for controlling the solid-state imaging element. This brings about an effect of improving usability.

Furthermore, in the first aspect, the control circuit may generate data by thinning out the image data on at least one of a row-by-row basis or a column-by-column basis as the compressed data. This brings about an effect of compressing image data in a simple manner.

Furthermore, in the first aspect, the signal processing circuit may include a compression processing unit that generates the compressed data by pixel addition. This brings about an effect of reducing noise.

Furthermore, in the first aspect, the signal processing circuit may further include a plurality of analog to digital converters that each converts the pixel signal into a digital signal, the pixel signal may include an analog signal, and the compression processing unit may generate the compressed data by adding the digital signals. This brings about an effect of reducing noise.

Furthermore, in the first aspect, the signal processing circuit may further include a plurality of analog to digital converters that each converts the pixel signal into a digital signal, the pixel signal may include an analog signal, and the compression processing unit may generate the compressed data by adding the pixel signals. This brings about an effect of reducing noise.

Furthermore, in the first aspect, a detection processing unit that performs predetermined detection processing on the compressed data may be further included. This brings about an effect of causing the detection target to be detected in the solid-state imaging element.

Furthermore, in the first aspect, the signal processing circuit may output the result of the processing to the outside of the solid-state imaging element. This brings about an effect of making the processing result available outside the solid-state imaging element.

Also, in the first aspect, the detection processing unit may detect whether or not a face is present. This brings about an effect of cutting out a region for face detection.

Furthermore, in the first aspect, the detection processing unit may detect whether or not a person is present. This brings about an effect of cutting out a region for person detection.

Furthermore, in the first aspect, the detection processing unit may detect a difference between the compressed data and predetermined background data. This brings about an effect of detecting the detection target in a simple manner.

Furthermore, in the first aspect, a communication interface that receives the result of the processing and supplies the result to the control circuit may be further included. This brings about an effect of reducing the processing load on the solid-state imaging element.

Furthermore, in the first aspect, the pixel signal may include a predetermined reset level and a signal level corresponding to an exposure amount, and each of the plurality of pixels may include: first and second capacitor elements; a pre-stage circuit that sequentially generates the reset level and the signal level and causes the first and second capacitor elements to hold the reset level and the signal level, respectively; a selection circuit that sequentially performs control to connect one of the first and second capacitor elements to a predetermined post-stage node, control to disconnect both of the first and second capacitor elements from the post-stage node, and control to connect another one of the first and second capacitor elements to the post-stage node; a post-stage reset transistor that initializes a level of the post-stage node when both of the first and second capacitor elements are disconnected from the post-stage node; and a post-stage circuit that sequentially reads the reset level and the signal level from the first and second capacitor elements via the post-stage node and outputs the reset level and the signal level. This brings about an effect of reducing kTC noise.

Furthermore, according to a second aspect of the present technology, provided is imaging system including: a solid-state imaging element including: a pixel array unit having an array of a plurality of pixels, each of the plurality of pixels being configured to generate a pixel signal and sample and hold the pixel signal; a vertical scanning circuit that drives each of a plurality of rows in the pixel array unit to output the pixel signal; a signal processing circuit that reads the pixel signal and performs predetermined signal processing on the pixel signal; and a control circuit that controls at least one of the vertical scanning circuit or the signal processing circuit to generate compressed data by compressing image data containing an array of the pixel signals, and controls at least one of the vertical scanning circuit or the signal processing circuit on the basis of a result of processing the compressed data to output cutout data, the cutout data corresponding to a predetermined region cut out from the image data; and a host that performs processing different from the processing on the basis of the cutout data. This brings about an effect of improving usability of the imaging system.

### BRIEF DESCRIPTION OF DRAWINGS

FIG. 1 is a diagram illustrating a configuration example of an imaging system according to a first embodiment of the present technology.

FIG. 2 is a block diagram illustrating a configuration example of a solid-state imaging element according to the first embodiment of the present technology.

FIG. 3 is a circuit diagram illustrating a configuration example of a pixel according to the first embodiment of the present technology.

FIG. 4 is a block diagram illustrating a configuration example of a load metal-oxide-semiconductor (MOS) circuit block and a column signal processing circuit according to the first embodiment of the present technology.

FIG. 5 is a diagram illustrating a usage example of the imaging system according to the first embodiment of the present technology.

FIG. 6 is a diagram illustrating an example of a detection region and a cutout region according to the first embodiment of the present technology.

FIG. 7 is a diagram illustrating another example of the detection region and the cutout region according to the first embodiment of the present technology.

FIG. 8 is a diagram illustrating an example of an overall view of the solid-state imaging element according to the first embodiment of the present technology.

FIG. 9 is a timing chart illustrating an example of how the imaging system according to the first embodiment of the present technology operates.

FIG. 10 is a timing chart illustrating an example of a global shutter operation according to the first embodiment of the present technology.

FIG. 11 is a timing chart illustrating an example of a read operation according to the first embodiment of the present technology.

FIG. 12 is a timing chart illustrating another example of the read operation according to the first embodiment of the present technology.

FIG. 13 is a timing chart illustrating an example of how an imaging system according to a first comparative example operates.

FIG. 14 is a timing chart illustrating an example of how an imaging system according to a second comparative example operates.

FIG. 15 is a diagram illustrating examples of image data, compressed data, and cutout data according to the first embodiment of the present technology.

FIG. 16 is a flowchart illustrating an example of how the solid-state imaging element according to the first embodiment of the present technology operates.

FIG. 17 is a flowchart illustrating an example of how a host according to the first embodiment of the present technology operates.

FIG. 18 is a block diagram illustrating a configuration example of a column signal processing circuit according to a second embodiment of the present technology.

FIG. 19 is a diagram illustrating examples of image data and compressed data according to the second embodiment of the present technology.

FIG. 20 is a block diagram illustrating another example of the column signal processing circuit according to the second embodiment of the present technology.

FIG. 21 is a block diagram illustrating a configuration example of a solid-state imaging element according to a third embodiment of the present technology.

FIG. 22 is a timing chart illustrating an example of how an imaging system according to the third embodiment of the present technology operates.

FIG. 23 is a diagram illustrating a configuration example of an imaging system according to a fourth embodiment of the present technology.

FIG. 24 is a timing chart illustrating an example of how the imaging system according to the fourth embodiment of the present technology operates.

FIG. 25 is a diagram illustrating a configuration example of an imaging system according to a fifth embodiment of the present technology.

FIG. 26 is a diagram for describing a usage example or the imaging system according to the fifth embodiment of the present technology.

FIG. 27 is a diagram illustrating examples of background data, compressed data, and cutout data according to a sixth embodiment of the present technology.

FIG. 28 is a circuit diagram illustrating a configuration example of a pixel according to a first modification example of the present technology.

FIG. 29 is a timing chart illustrating an example of a global shutter operation according to the first modification example of the present technology.

FIG. 30 is a timing chart illustrating an example of a read operation according to the first modification example of the present technology.

FIG. 31 is a diagram illustrating an example of a multilayer structure of a solid-state imaging element according to a second modification example of the present technology.

FIG. 32 is a circuit diagram illustrating a configuration example of a pixel according to the second modification example of the present technology.

FIG. 33 is a diagram illustrating an example of a multilayer structure of a solid-state imaging element according to a third modification example of the present technology.

FIG. 34 is a circuit diagram illustrating a configuration example of a pixel according to a seventh embodiment of the present technology.

FIG. 35 is a timing chart illustrating an example of a global shutter operation according to the seventh embodiment of the present technology.

FIG. 36 is a circuit diagram illustrating a configuration example of a pixel according to an eighth embodiment of the present technology.

FIG. 37 is a diagram for describing reset feedthrough according to the eighth embodiment of the present technology.

FIG. 38 is a diagram for describing variations in level caused by reset feedthrough according to the eighth embodiment of the present technology.

FIG. 39 is a timing chart illustrating an example of voltage control according to the eighth embodiment of the present technology.

FIG. 40 is a timing chart illustrating an example of a global shutter operation for odd frames according to a ninth embodiment of the present technology.

FIG. 41 is a timing chart illustrating an example of a read operation for odd frames according to the ninth embodiment of the present technology.

FIG. 42 is a timing chart illustrating an example of a global shutter operation for even frames according to the ninth embodiment of the present technology.

FIG. 43 is a timing chart illustrating an example of a read operation for even frames according to the ninth embodiment of the present technology.

FIG. 44 is a circuit diagram illustrating a configuration example of a column signal processing circuit according to a tenth embodiment of the present technology.

FIG. 45 is a timing chart illustrating an example of a global shutter operation according to the tenth embodiment of the present technology.

FIG. 46 is a timing chart illustrating an example of a read operation according to the tenth embodiment of the present technology.

FIG. 47 is a timing chart illustrating an example of a rolling shutter operation according to an eleventh embodiment of the present technology.

FIG. 48 is a block diagram illustrating a configuration example of a solid-state imaging element according to a twelfth embodiment of the present technology.

FIG. 49 is a circuit diagram illustrating a configuration example of a dummy pixel, a regulator, and a switching unit according to the twelfth embodiment of the present technology.

FIG. 50 is a timing chart illustrating an example of how the dummy pixel and the regulator according to the twelfth embodiment of the present technology operate.

FIG. 51 is a circuit diagram illustrating a configuration example of an effective pixel according to the twelfth embodiment of the present technology.

FIG. 52 is a timing chart illustrating an example of a global shutter operation according to the twelfth embodiment of the present technology.

FIG. 53 is a timing chart illustrating an example of a read operation according to the twelfth embodiment of the present technology.

FIG. 54 is a diagram for describing effects according to the twelfth embodiment of the present technology.

FIG. 55 is a block diagram illustrating a schematic configuration example of a vehicle control system.

FIG. 56 is an explanatory diagram illustrating an example of an installation position of an imaging section.

### MODE FOR CARRYING OUT THE INVENTION

Modes for carrying out the present technology (hereinafter, referred to as embodiments) will be described below. The description will be given in the following order.
1. First embodiment (example where cutout is performed on the basis of the result of processing compressed data)
2. Second embodiment (example where cutout is performed on the basis of the result of processing compressed data generated by pixel addition)
3. Third embodiment (example where cutout is performed on the basis of the result of processing compressed data and host becomes inactive)
4. Fourth embodiment (example where host processes compressed data and solid-state imaging element performs cutout on the basis of the result of the processing)
5. Fifth embodiment (example where solid-state imaging element performs cutout on the basis of the result of processing compressed data and host performs action determination)
6. Sixth embodiment (example where cutout is performed on the basis of difference between compressed data and background)
7. Seventh embodiment (example where discharge transistor is added and first and second capacitor elements hold pixel signal)
8. Eighth embodiment (example where first and second capacitor elements hold pixel signal and reset power supply voltage is controlled)
9. Ninth embodiment (example where first and second capacitor elements hold pixel signal and level to be held is switched for each frame)
10. Tenth embodiment (example where first and second capacitor elements hold pixel signal and black spot phenomenon is suppressed)
11. Eleventh embodiment (example where first and second capacitor elements hold pixel signal and rolling shutter operation is performed)
12. Twelfth embodiment (example where noise is reduced and first and second capacitor elements hold pixel signal)
13. Example of application to mobile body

### 1. First Embodiment

### [Configuration Example of Imaging System]

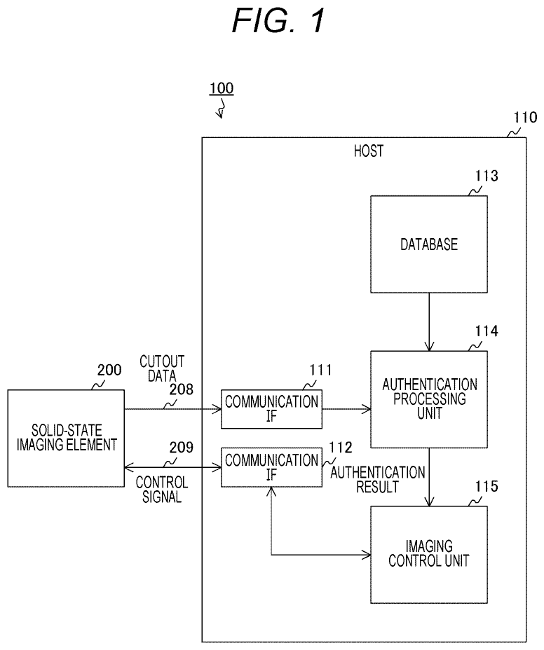

FIG. 1 is a diagram illustrating a configuration example of an imaging system 100 according to a first embodiment of the present technology. The imaging system 100 is a system configured to capture image data (i.e., frames) and perform various types of processing such as authentication processing, and includes a solid-state imaging element 200 and a host 110.

The solid-state imaging element 200 captures image data. Furthermore, the solid-state imaging element 200 cuts out a region subject to authentication such as a face or an eye from the captured image data, and supplies the cutout region as cutout data to the host 110 through a predetermined number of signal lines 208.

Furthermore, the solid-state imaging element 200 transmits and receives a control signal related to control to and from the host 110 through a predetermined number of signal lines 209. The control signal includes, for example, a vertical synchronization signal, an imaging parameter, an authentication result, status information, and the like. The imaging parameter includes an international organization for standardization (ISO) sensitivity, an exposure time, a setting value such as an aperture value and white balance, and the like.

The host 110 is a device or a circuit that performs the authentication processing on the basis of the cutout data. The host 110 includes communication interfaces 111 and 112, a database 113, an authentication processing unit 114, and an imaging control unit 115.

The communication interface 111 receives the cutout data and supplies the cutout data to the authentication processing unit 114. Examples of a standard applied to the communication interface 111 include a relatively high-speed standard such as scalable low voltage signaling with embedded clock (SLVS-EC).

The communication interface 112 transmits and receives the control signal to and from the imaging control unit 115. Examples of a standard applied to the communication interface 112 include a relatively low-speed standard such as inter-integrated circuit (I2C) and serial peripheral interface (SPI) is used.

The database 113 holds registration information registered in advance before authentication. The authentication processing unit 114 performs the authentication processing on the basis of the cutout data. The authentication processing unit 114 obtains a feature of the cutout data received from the communication interface 111, and compares the obtained feature with a feature of the registration information to determine whether or not a similarity between the features is greater than or equal to a specific value. The authentication processing unit 114 determines that the authentication has succeeded in a case where the similarity is greater than or equal to the specific value, and determines that the authentication has failed in a case where the similarity is less than the specific value. The authentication processing unit 114 supplies the authentication result to the imaging control unit 115.

Note that the database 113 can also be deployed on a server located outside the host 110. In this case, the host 110 receives the registration information from the server over a network such as the Internet.

The imaging control unit 115 controls the solid-state imaging element 200. The imaging control unit 115 transmits and receives, as necessary, the control signal to and from the solid-state imaging element 200 via the communication interface 112. Furthermore, upon receipt of the authentication result, the imaging control unit 115 transmits the authentication result to the solid-state imaging element 200.

### [Configuration Example of Solid-State Imaging Element]

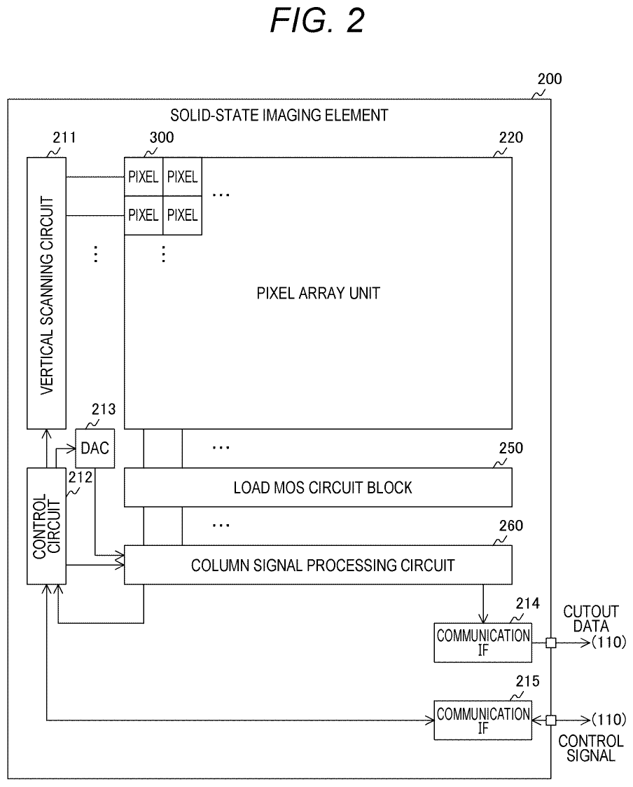

FIG. 2 is a block diagram illustrating a configuration example of the solid-state imaging element 200 according to the first embodiment of the present technology. The solid-state imaging element 200 includes a vertical scanning circuit 211, a control circuit 212, and a digital to analog converter (DAC) 213. Furthermore, the solid-state imaging element 200 includes a pixel array unit 220, a load metal oxide semiconductor (MOS) circuit block 250, a column signal processing circuit 260, and communication interfaces 214 and 215.

In the pixel array unit 220, a plurality of pixels 300 is arranged in a two-dimensional grid pattern. Furthermore, each circuit in the solid-state imaging element 200 is provided in, for example, a single semiconductor chip.

Hereinafter, a set of pixels 300 arranged in a horizontal direction will be referred to as “row”, and a set of pixels 300 arranged in a direction orthogonal to the row will be referred to as “column”.

The control circuit 212 controls the operation of each of the vertical scanning circuit 211, the DAC 213, and the column signal processing circuit 260 in accordance with the control signal received from the communication interface 215.

The DAC 213 generates a sawtooth-wave ramp signal through digital to analog (DA) conversion. The DAC 213 supplies the generated ramp signal to the column signal processing circuit 260.

The vertical scanning circuit 211 sequentially selects and drives rows to output an analog pixel signal. The pixel 300 photoelectrically converts incident light to generate the analog pixel signal. This pixel 300 supplies the pixel signal to the column signal processing circuit 260 via the load MOS circuit block 250.

In the load MOS circuit block 250, a MOS transistor that supplies a constant current is provided for each column.

The column signal processing circuit 260 performs signal processing such as AD conversion processing or CDS processing on the pixel signal for each column. The column signal processing circuit 260 generates cutout data through the signal processing and supplies the cutout data to the communication interface 214. Note that the column signal processing circuit 260 is an example of a signal processing circuit described in the claims.

The communication interface 214 transmits the cutout data to the host 110. The communication interface 215 transmits and receives the control signal to and from the host 110.

### [Configuration Example of Pixel]

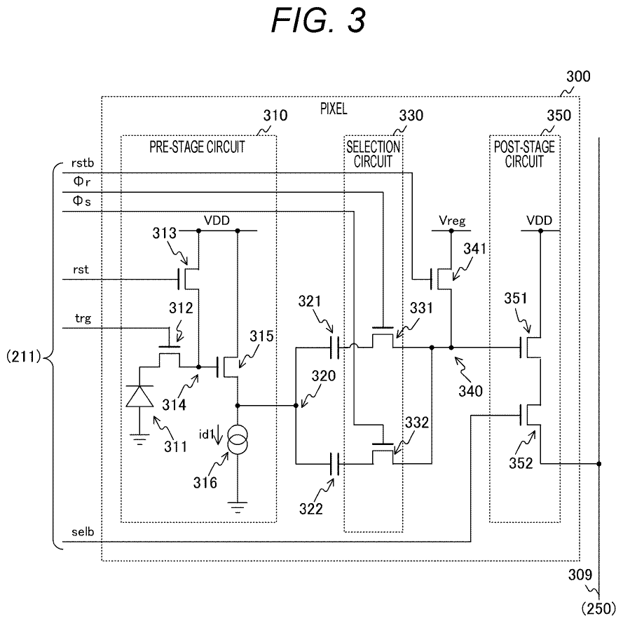

FIG. 3 is a circuit diagram illustrating a configuration example of the pixel 300 according to the first embodiment of the present technology. The pixel 300 includes a pre-stage circuit 310, capacitor elements 321 and 322, a selection circuit 330, a post-stage reset transistor 341, and a post-stage circuit 350.

The pre-stage circuit 310 includes a photoelectric conversion element 311, a transfer transistor 312, a floating diffusion (FD) reset transistor 313, an FD 314, a pre-stage amplification transistor 315, and a current source transistor 316.

The photoelectric conversion element 311 generates charges through photoelectric conversion. The transfer transistor 312 transfers the charges from the photoelectric conversion element 311 to the FD 314 in accordance with a transfer signal trg received from the vertical scanning circuit 211.

The FD reset transistor 313 extracts the charges from the FD 314 to initialize the FD 314 in accordance with an FD reset signal rst received from the vertical scanning circuit 211. The FD 314 accumulates charges, and generates a voltage corresponding to the amount of the charges. The pre-stage amplification transistor 315 amplifies a level of the voltage of the FD 314, and outputs the amplified voltage to a pre-stage node 320.

Furthermore, the FD reset transistor 313 and the pre-stage amplification transistor 315 have their respective sources connected to a power supply voltage VDD. The current source transistor 316 is connected to a drain of the pre-stage amplification transistor 315. The current source transistor 316 supplies a current id1 under the control of the vertical scanning circuit 211.

The capacitor elements 321 and 322 have their respective one ends commonly connected to the pre-stage node 320 and have their respective other ends connected to the selection circuit 330. Note that the capacitor elements 321 and 322 are examples of first and second capacitor elements described in the claims.

The selection circuit 330 includes a selection transistor 331 and a selection transistor 332. The selection transistor 331 opens and closes a path between the capacitor element 321 and a post-stage node 340 in accordance with a selection signal Ør received from the vertical scanning circuit 211. The selection transistor 332 opens and closes a path between the capacitor element 322 and the post-stage node 340 in accordance with a selection signal Φs received from the vertical scanning circuit 211.

The post-stage reset transistor 341 initializes a level of the post-stage node 340 to a predetermined potential Vreg in accordance with a post-stage reset signal rstb received from the vertical scanning circuit 211. A potential different from the power supply voltage VDD (a potential lower than VDD, for example) is set as the potential Vreg.

The post-stage circuit 350 includes a post-stage amplification transistor 351, and a post-stage selection transistor 352. The post-stage amplification transistor 351 amplifies the level of the post-stage node 340. The post-stage selection transistor 352 outputs a signal indicating the level amplified by the post-stage amplification transistor 351 to a vertical signal line 309 as a pixel signal in accordance with a post-stage selection signal selb received from the vertical scanning circuit 211.

Note that, for example, n-channel metal oxide semiconductor (nMOS) transistors are used as various transistors (transfer transistor 312 and the like) in the pixel 300.

The vertical scanning circuit 211 supplies a high-level FD reset signal rst and a high-level transfer signal trg to all the pixels at the start of exposure. As a result, the photoelectric conversion element 311 is initialized. Hereinafter, this control is referred to as “PD reset”.

The vertical scanning circuit 211 then supplies the high-level FD reset signal rst over a pulse period with the post-stage reset signal rstb and the selection signal Φr set to the high level for all the pixels, immediately before the end of exposure. As a result, the FD 314 is initialized, and a level corresponding to the level of the FD 314 at that time is held in the capacitor element 321. This control is hereinafter referred to as “FD reset”.

The level of the FD 314 at the time of FD reset and the level corresponding to the level of the FD 314 (the level held in the capacitor element 321 and the level of the vertical signal line 309) will be hereinafter collectively referred to as “P-phase” or “reset level”.

At the end of exposure, the vertical scanning circuit 211 supplies the high-level transfer signal trg over the pulse period with the post-stage reset signal rstb and the selection signal Φs set to the high level for all the pixels. As a result, signal charges corresponding to an exposure amount are transferred to the FD 314, and a level corresponding to the level of the FD 314 at that time is held in the capacitor element 322.

The level of the FD 314 at the time of transfer of signal charges and the level corresponding to the level of the FD 314 (the level held in the capacitor element 322 and the level of the vertical signal line 309) will be hereinafter collectively referred to as “D-phase” or “signal level”.

Such exposure control that starts and ends exposure simultaneously for all the pixels is called a global shutter method. Through this exposure control, the pre-stage circuits 310 of all the pixels sequentially generate the reset level and the signal level. The reset level is held in the capacitor element 321, and the signal level is held in the capacitor element 322.

After the end of exposure, the vertical scanning circuit 211 sequentially selects rows, and sequentially outputs the reset level and the signal level of the selected row. To output the reset level, the vertical scanning circuit 211 supplies the high-level selection signal Φr over a predetermined period with the FD reset signal rst and the post-stage selection signal selb of the selected row set to the high level. As a result, the capacitor element 321 is connected to the post-stage node 340, and the reset level is read.

After reading the reset level, the vertical scanning circuit 211 supplies the high-level post-stage reset signal rstb over the pulse period with the FD reset signal rst and the post-stage selection signal selb of the selected row kept at the high level. As a result, the level of the post-stage node 340 is initialized. At this time, both the selection transistor 331 and the selection transistor 332 are in an open state, and the capacitor elements 321 and 322 are disconnected from the post-stage node 340.

After the initialization of the post-stage node 340, the vertical scanning circuit 211 supplies the high-level selection signal Φs over a predetermined period with the FD reset signal rst and the post-stage selection signal selb of the selected row kept at the high level. As a result, the capacitor element 322 is connected to the post-stage node 340, and the signal level is read.

Through the above-described read control, the selection circuit 330 of the selected row sequentially performs control to connect the capacitor element 321 to the post-stage node 340, control to disconnect the capacitor elements 321 and 322 from the post-stage node 340, and control to connect the capacitor element 322 to the post-stage node 340. Furthermore, when the capacitor elements 321 and 322 are disconnected from the post-stage node 340, the post-stage reset transistor 341 of the selected row initializes the level of the post-stage node 340. Furthermore, the post-stage circuit 350 of the selected row sequentially reads the reset level and the signal level from the capacitor elements 321 and 322 via the post-stage node 340, and outputs the reset level and the signal level to the vertical signal line 309.

### [Configuration Example of Column Signal Processing Circuit]

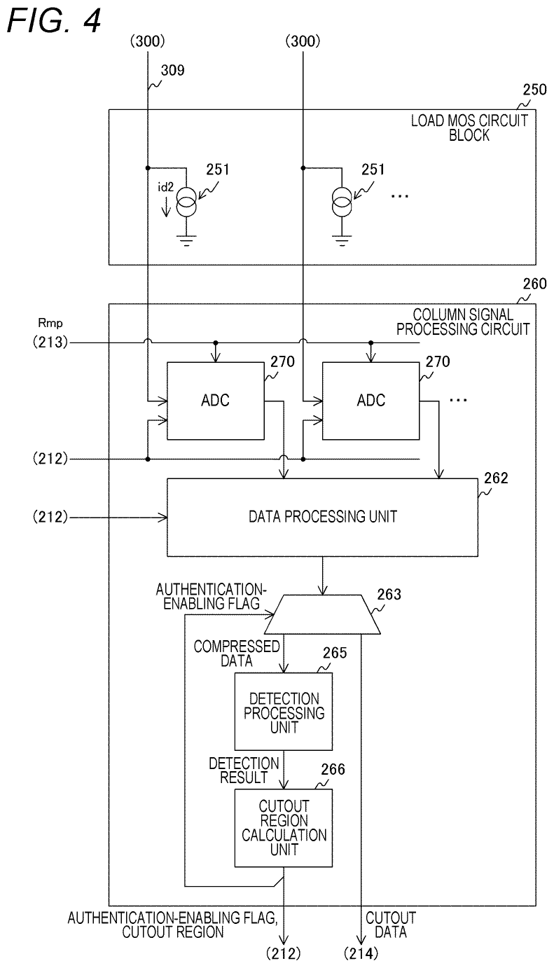

FIG. 4 is a block diagram illustrating a configuration example of the load MOS circuit block 250 and the column signal processing circuit 260 according to the first embodiment of the present technology.

In the load MOS circuit block 250, the vertical signal line 309 is wired for each column. When the number of columns is I (where I is an integer), I vertical signal lines 309 are wired. Furthermore, a load MOS transistor 251 that supplies a constant current id2 is connected to each of the vertical signal lines 309.

The column signal processing circuit 260 is provided with a plurality of analog to digital converters (ADCs) 270, a data processing unit 262, a demultiplexer 263, a detection processing unit 265, and a cutout region calculation unit 266. The ADCs 270 are provided on a one-to-one basis for the columns. When the number of columns is I, I ADCs 270 are provided.

Each ADC 270 converts an analog pixel signal received from the corresponding column into a digital signal using a ramp signal Rmp received from the DAC 213. The ADC 270 supplies the digital signal to the data processing unit 262. For example, a single-slope ADC including a comparator and a counter is provided as the ADC 270.

Here, it is assumed that the control circuit 212 can control at least one of the vertical scanning circuit 211 or the column signal processing circuit 260 to generate compressed data by compressing image data.

For example, the control circuit 212 generates, as the compressed data, data by thinning out image data on at least one of a row-by-row basis or a column-by-column basis. In a case where thinning is performed on a row-by-row basis, the control circuit 212 controls the vertical scanning circuit 211 to sequentially select and drive rows except for rows to be skipped. Furthermore, in a case where thinning is performed on a column-by-column basis, the control circuit 212 controls each of the ADCs 270 to disable ADCs 270 corresponding to columns to be skipped and enable the remaining ADCs 270.

Note that the control circuit 212 can also generate the compressed data by pixel addition to be described later.

Here, it is assumed that the control circuit 212 can control at least one of the vertical scanning circuit 211 or the column signal processing circuit 260 to generate cutout data by cutting out a part of image data.

In the case where the cutout data is generated, the control circuit 212 controls the vertical scanning circuit 211 to sequentially drive all the rows in the cutout region, and enables ADCs 270 corresponding to all the columns in the region and disables the remaining ADCs 270. The cutout region is cut out from uncompressed image data, so that the cutout region is higher in resolution than the compressed data. Such a region is also called region of interest (ROI).

The data processing unit 262 performs predetermined signal processing such as CDS processing on the digital signal for each column. The data processing unit 262 supplies the processed digital signal to the demultiplexer 263.

The demultiplexer 263 selects one of the detection processing unit 265 or the communication interface 214 as an output destination in accordance with an authentication-enabling flag, and outputs data from the data processing unit 262 to the output destination.

Here, when a predetermined object (such as a face) is detected in the compressed data, the authentication-enabling flag serves as a flag indicating whether or not a region of the object has an image quality high enough for authentication. In a case where authentication is not possible, the authentication-enabling flag is set to “0”, for example. In a case where authentication is possible, for example, the authentication-enabling flag is set to “1”, for example. In the initial state, the authentication-enabling flag is set to “0”.

In a case where the authentication-enabling flag is “0”, the control circuit 212 generates compressed data. Furthermore, the demultiplexer 263 outputs the compressed data to the detection processing unit 265. On the other hand, in a case where the authentication-enabling flag is “1”, the control circuit 212 outputs cutout data, and the demultiplexer 263 outputs the cutout data to the host 110 via the communication interface 214.

The detection processing unit 265 performs detection processing of detecting whether or not a predetermined detection target (such as a face) is present on the compressed data. The detection processing unit 265 supplies the detection result to the cutout region calculation unit 266. The detection result includes information indicating success or failure of detection and a detection region that is a region subject to detection.

The cutout region calculation unit 266 calculate a cutout region as necessary. In a case where the target object is not detected by the detection processing unit 265, the cutout region calculation unit 266 sets the authentication-enabling flag to “0” and supplies the authentication-enabling flag to the demultiplexer 263 and the control circuit 212.

In a case where the target object is detected by the detection processing unit 265, the cutout region calculation unit 266 determines whether or not the region of the target object has an image quality high enough for authentication. In a case where authentication is not possible, the cutout region calculation unit 266 sets the authentication-enabling flag to “0” and supplies the authentication-enabling flag to the demultiplexer 263 and the control circuit 212.

In a case where authentication is possible, the cutout region calculation unit 266 sets the authentication-enabling flag to “1” and supplies the authentication-enabling flag to the demultiplexer 263 and the control circuit 212. In a case where the detection target and the authentication target are the same, the cutout region calculation unit 266 sets the detection region as a cutout region, and supplies information indicating the region to the control circuit 212. On the other hand, in a case where a part (such as an eye) of the detection target (such as a face) is subject to authentication, the cutout region calculation unit 266 calculates the region subject to authentication as a cutout region, and supplies the region to the control circuit 212.

In a case where the authentication-enabling flag is “1”, the control circuit 212 controls at least one of the vertical scanning circuit 211 or the column signal processing circuit 260 to output the pixel signals of all the pixels in the cutout region. Furthermore, in a case where the authentication-enabling flag is “0” for the second frame and subsequent frames from the start of imaging, the control circuit 212 changes the imaging parameter (ISO sensitivity, aperture, exposure time, white balance, etc.) as necessary.

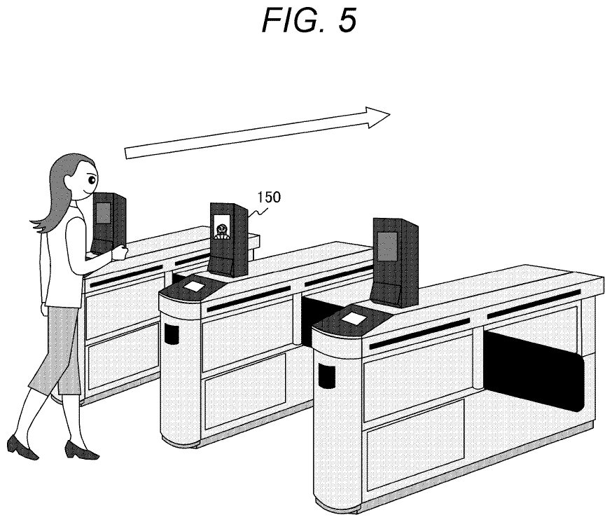

FIG. 5 is a diagram illustrating a usage example of the imaging system 100 according to the first embodiment of the present technology. The imaging system 100 is used in, for example, an access control system including an imaging device 150. The imaging device 150 is installed near a gate and captures an image of a face of a person passing through the gate in the direction of the arrow. The imaging device 150 is provided with the solid-state imaging element 200.

In the access control system illustrated in the drawing, in order to ensure security, authentication is performed as to whether or not a person entering and exiting is a pre-registered individual. Authentication using an integrated circuit (IC) card is also possible, but biometric authentication using a face, an eye, or the like may be performed due to concerns about hygiene or the risk of losing the IC card.

In a case where face authentication or the like is performed on the basis of image data captured by the imaging device 150, the host 110 needs to perform the authentication processing at a speed corresponding to a speed at which a person passes through the gate. For example, in a case where a person walks fast, the number of steps per hour is about 8000 steps, and the number of steps per second is about 2.2 steps. Since the average stride length of adults is 70 cm, a distance traveled per second is about 1.5 meters (m). In a case where a distance at which an image can be captured with an image quality high enough for authentication is about 1.5 meters (m) from the imaging device 150, the imaging system 100 needs to complete processing from imaging to authentication within 1 second, and a high throughput is therefore required. In a case where the throughput is not high enough, a person needs to stop until the processing is completed, which deteriorates usability.

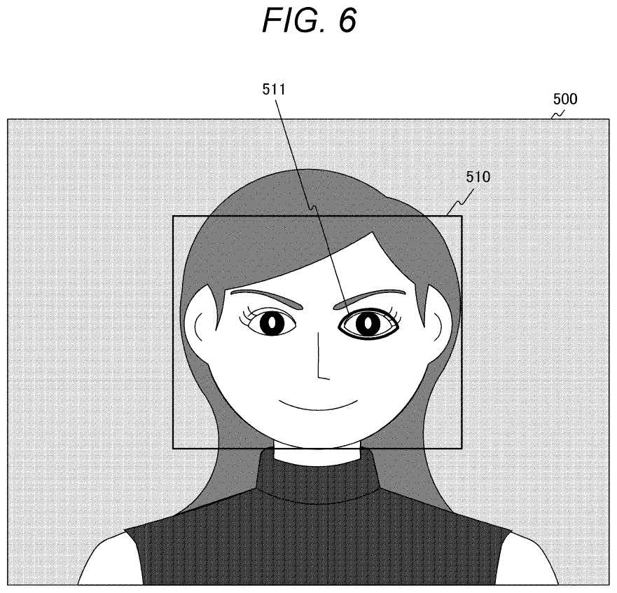

FIG. 6 is a diagram illustrating an example of the detection region and the cutout region according to the first embodiment of the present technology. It is assumed that the solid-state imaging element 200 detects whether or not a face is present, and the host 110 authenticates an eye of the face.

The solid-state imaging element 200 captures image data, compresses the image data to generate compressed data 500, and performs face detection processing on the compressed data 500. Processing from the detection of a face or the like to the identification of the authentication region such as an eye is general processing. Therefore, the detection processing can be performed in the solid-state imaging element 200. Furthermore, the detection processing can be performed with a coarse image, so that compressed data can be used for the detection processing.

Here, each of the pixels 300 can sample and hold the pixel signal, so that the original image data before compression is held in the pixel array unit 220 over a period from reading of compressed data to the end of the next exposure. Therefore, the solid-state imaging element 200 can read the original image data again before the end of the next exposure. When a face is detected, the solid-state imaging element 200 cuts out a region subject to authentication such as an eye from a detection region 510 of the original image data as a cutout region 511, and outputs the cutout region 511 to the host 110. Then, the host 110 performs the authentication processing on the cutout region 511.

High accuracy is required for the authentication processing, so that a high-definition image cut out from the original image data before compression is used.

Furthermore, the authentication processing requires registration data on a person subject to authentication, and from the viewpoint of security and privacy, an advanced security technology is required for protecting the registration data. Therefore, the authentication processing is performed by the host 110 located outside the solid-state imaging element 200.

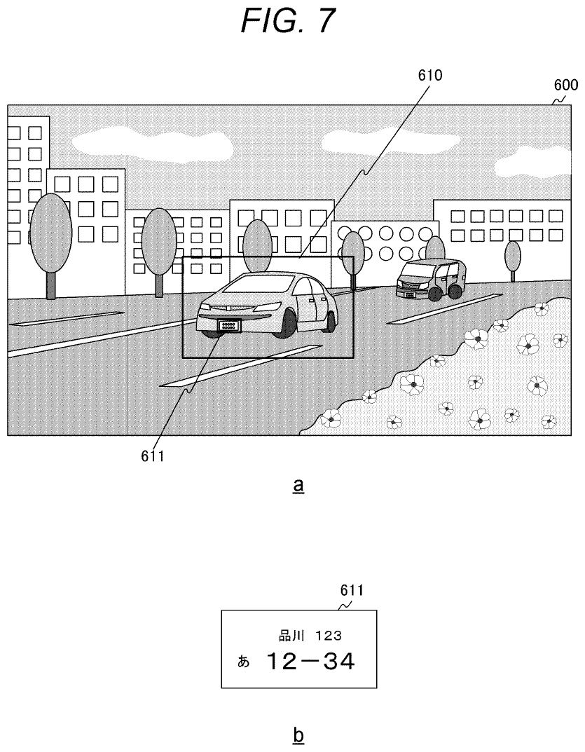

FIG. 7 is a diagram illustrating another example of the detection region and the cutout region according to the first embodiment of the present technology. In FIGS. 5 and 6, although the imaging system 100 is applied to the access control system, the imaging system 100 can also be applied to the transportation field. In this case, for example, as illustrated in a of FIG. 7, the solid-state imaging element 200 detects whether or not a vehicle is present in compressed data 600. When the vehicle is detected, as illustrated in b of FIG. 7, the solid-state imaging element 200 cuts out, as a cutout region 611, a region of a license plate from a cutout region 610 of the original image data, and outputs the cutout region 611 to the host 110.

Note that the detection region and the cutout region are not limited to the above-described regions such as a face, an eye, a vehicle, and a license plate. The solid-state imaging element 200 can set, in a manner that depends on a use case, any desired region as the detection region and cut out the region as the cutout region.

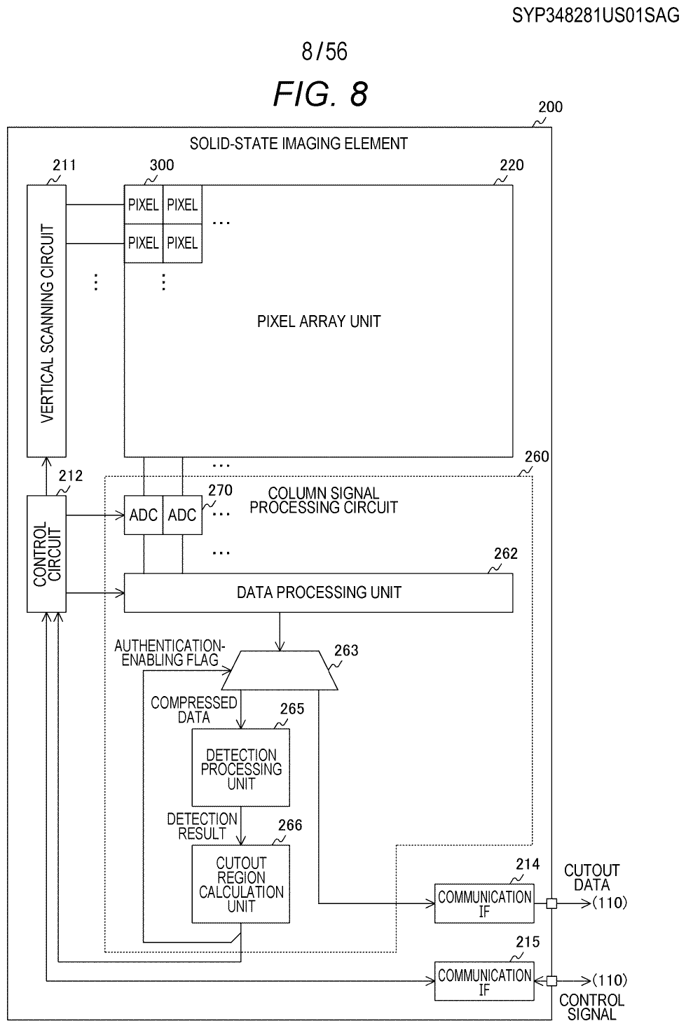

FIG. 8 is a diagram illustrating an example of an overall view of the solid-state imaging element 200 according to the first embodiment of the present technology. Each of the plurality of pixels 300 arranged in the pixel array unit 220 generates an analog pixel signal, and samples and holds the analog pixel signal.

The vertical scanning circuit 211 drives each of the plurality of rows in the pixel array unit 220 to output the pixel signal. The column signal processing circuit 260 performs signal processing such as analog to digital (AD) conversion processing on the pixel signal for each column.

The control circuit 212 controls the vertical scanning circuit 211 in synchronization with a vertical scanning signal to expose all the pixels simultaneously.

Furthermore, in the initial state, the authentication-enabling flag is set to “0”. In a case where the authentication-enabling flag is “0”, the control circuit 212 controls at least one of the vertical scanning circuit 211 or the column signal processing circuit 260 to generate compressed data by compressing image data. For example, data obtained by thinning out the image data on at least one of a row-by-row basis or a column-by-column basis is generated as the compressed data.

In a case where the authentication-enabling flag is “0”, the demultiplexer 263 supplies the compressed data to the detection processing unit 265. The detection processing unit 265 performs detection processing such as face detection on the compressed data. When the detection target is detected, the cutout region calculation unit 266 determines whether or not an image in the detection region has an image quality high enough for authentication, and in a case where authentication is possible, the cutout region calculation unit sets the authentication-enabling flag to “1” and supplies the authentication-enabling flag to the demultiplexer 263 and the control circuit 212. Furthermore, the cutout region calculation unit 266 calculates a cutout region as necessary, and supplies information indicating the region to the control circuit 212.

The control circuit 212 controls at least one of the vertical scanning circuit 211 or the column signal processing circuit 260 on the basis of the result of processing the compressed data (authentication-enabling flag or the like), and outputs cutout data obtained by cutting out the cutout region from the original image data. For example, in a case where the authentication-enabling flag is “1”, the cutout data is output. Furthermore, in a case where the authentication-enabling flag is “0” for the second frame and subsequent frames from the start of imaging, the control circuit 212 changes the imaging parameter as necessary.

### [Example of how Imaging System Operates]

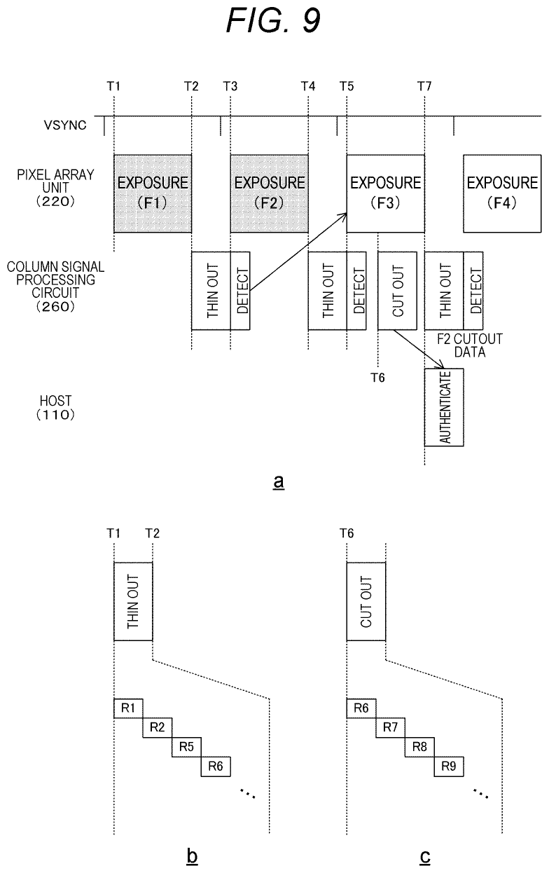

FIG. 9 is a timing chart illustrating an example of how the imaging system 100 according to the first embodiment of the present technology operates. Of the drawing, a illustrates how the entire imaging system 100 operates. Of the drawing, b illustrates a thinning operation of the solid-state imaging element 200, and c illustrates a cutout operation of the solid-state imaging element 200.

As illustrated in a of the drawing, it is assumed that imaging is started at timing T1. The control circuit 212 exposes all the pixels in the pixel array unit 220 simultaneously over an exposure time from timing T1 to timing T2 synchronized with a vertical synchronization signal VSYNC. That is, the exposure is controlled by the global shutter method. Furthermore, all the pixels in the pixel array unit 220 hold the pixel signals at the end of exposure. As a result, a first piece of image data (frame) F1 is generated.

In a read period from timing T2 to timing T3, the column signal processing circuit 260 generates compressed data by thinning out the frame F1. Then, after timing T3, the column signal processing circuit 260 performs detection processing on the compressed data. It is assumed that this detection processing has failed.

On the other hand, all the pixels in the pixel array unit 220 are exposed simultaneously over an exposure time from timing T3 to timing T4, and a second frame F2 is held accordingly.

In a read period from timing T4 to timing T5, the column signal processing circuit 260 generates compressed data by thinning out the frame F2. Then, after timing T5, the column signal processing circuit 260 performs detection processing on the compressed data. It is assumed that this detection processing has succeeded, and authentication is possible. In this case, after timing T6, the column signal processing circuit 260 outputs, to the host 110, cutout data obtained by cutting out a part of the original frame F2. Here, sampling and holding on a pixel-by-pixel basis allows the frame F2 to be held without being destroyed until the end of exposure for the next frame F3. Therefore, the column signal processing circuit 260 can read the pixel signals in the frame F2 again after timing T6.

Furthermore, upon failure of detection performed on the compressed data of the frame F1, the control circuit 212 changes the imaging parameter and exposes all the pixels in the pixel array unit 220 simultaneously over an exposure time from timing T5 to timing T7. For example, an increase in ISO sensitivity leads to generation of the frame F3 brighter than the frames F1 and F2.

The host 110 is activated at or before timing T1 corresponding to the start of imaging, and performs the authentication processing on cutout data after timing T7. The cutout data is data cut out from the original frame F2 of the compressed data subjected to the detection processing. That is, a frame subject to detection and a frame subject to authentication are the same. Furthermore, since each pixel samples and holds the pixel signal, it is not necessary to additionally provide a frame memory for holding the frame F2 during detection outside the pixel.

After the output of the cutout data, the imaging system 100 may perform the detection processing and the authentication processing again, or may suspend the detection processing and the authentication processing for a certain period of time. In a case of suspension, for example, the imaging system 100 may become inactive when the authentication processing has succeeded, and repeat the detection processing and the authentication processing when the authentication processing has failed. This is because it is not necessary to repeatedly authenticate the same recognition target. In a case of suspension at the time of success, the host 110 notifies the solid-state imaging element 200 of whether or not the authentication has succeeded.

In b and c of the drawing, “Rn” represents the n-th row. As illustrated in b of the drawing, in a case where thinning readout is performed, rows of R3, R4, and the like are skipped, and rows of R1, R2, R5, R6, and the like are sequentially read.

Furthermore, as illustrated in c of the drawing, in a case where cutout is performed after R6, all the rows in the cutout region such as R6, R7, R8, and R9 are sequentially read.

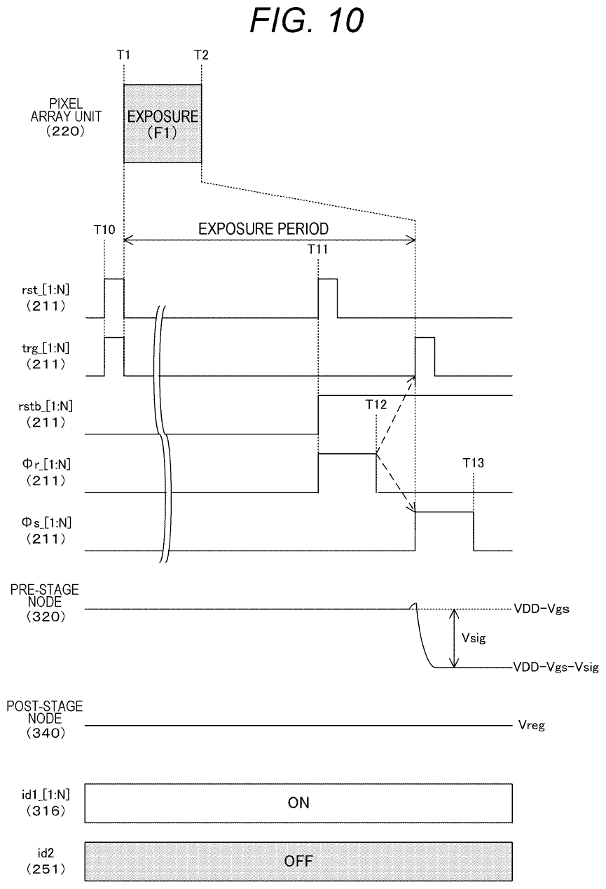

FIG. 10 is a timing chart illustrating an example of a global shutter operation according to the first embodiment of the present technology. The vertical scanning circuit 211 supplies the high-level FD reset signal rst and the high-level transfer signal trg to all the rows (in other words, all the pixels) over a period from timing T10 immediately before the start of exposure to timing T1 that is the end of the pulse period. As a result, all the pixels are PD reset, and the exposure simultaneously starts for all the rows.

Here, rst_[n] and trg_[n] in the drawing represents signals to the pixels in the n-th row among N rows. N is an integer indicating the total number of rows, and n is an integer from 1 to N.

Then, at timing T11 immediately before the end of the exposure period, the vertical scanning circuit 211 supplies the high-level FD reset signal rst over the pulse period with the post-stage reset signal rstb and the selection signal Φr set to the high level for all the pixels. As a result, all the pixels are FD reset, and the reset level is sampled and held. Here, rstb_[n] and Φr_[n] in the drawing represents signals to the pixels in the n-th row.

At timing T12 after timing T11, the vertical scanning circuit 211 returns the selection signal Φr to the low level.

At timing T2 that is the end of exposure, the vertical scanning circuit 211 supplies the high-level transfer signal trg over the pulse period with the post-stage reset signal rstb and the selection signal Φs set to the high level for all the pixels. As a result, the signal level is sampled and held. Furthermore, the level of the pre-stage node 320 drops from the reset level (VDD-Vgs) to the signal level (VDD-Vgs-Vsig). Here, VDD represents the power supply voltage, and Vsig represents a net signal level obtained by the CDS processing. Vgs represents a gate-source voltage of the pre-stage amplification transistor 315. Furthermore, Φs_[n] in the drawing represents signals to the pixels in the n-th row.

At timing T13 after timing T2, the vertical scanning circuit 211 returns the selection signal Φs to the low level.

Furthermore, the vertical scanning circuit 211 controls the current source transistors 316 of all the rows (all the pixels) to supply the current id1. Here, id1_[n] in the drawing represents the current of the pixels in the n-th row. The larger the current id, the larger the IR drop; therefore, the current id1 needs to be on the order of several nanoamperes (nA) to several tens of nanoamperes (nA). On the other hand, the load MOS transistors 251 of all the columns are in an off state, and the current id2 is not supplied to the vertical signal line 309 accordingly.

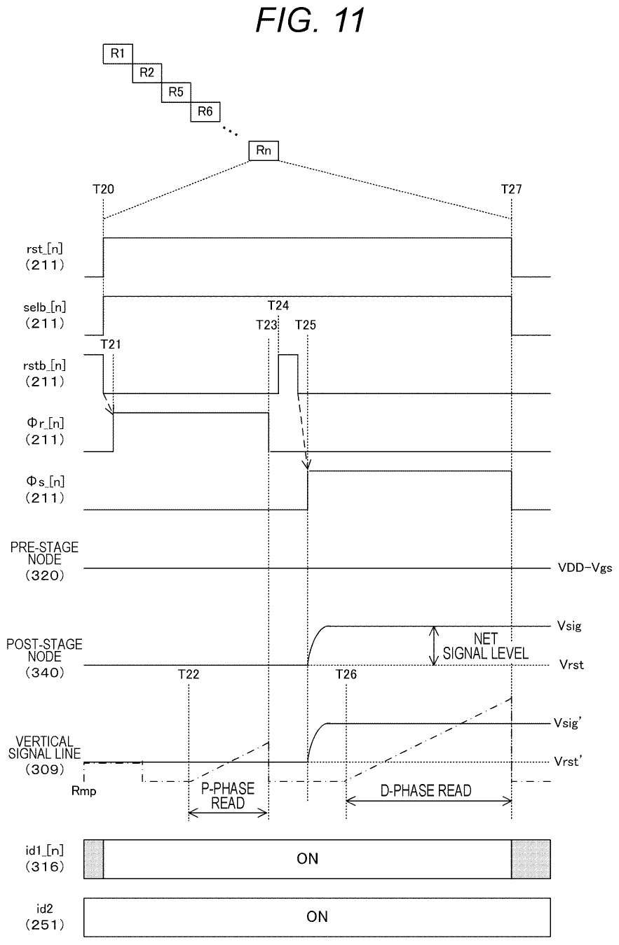

FIG. 11 is a timing chart illustrating an example of a read operation according to the first embodiment of the present technology. During a read period of the n-th row from timing T20 to timing T27, the vertical scanning circuit 211 sets the FD reset signal rst and the post-stage selection signal selb of the n-th row to the high level. Here, selb_[n] in the drawing represents signals to the pixels in the n-th row.

The vertical scanning circuit 211 supplies the high-level selection signal Φr to the n-th row over a period from timing T21 immediately after timing T20 to timing T23. The potential of the post-stage node 340 becomes the reset level Vrst.

The DAC 213 gradually increases the ramp signal Rmp over a period from timing T22 after timing T21 to timing T23. The ADC 270 compares the ramp signal Rmp with a level Vrst′ of the vertical signal line 309, and counts a count value over a period until the comparison result is inverted. As a result, the P-phase level (reset level) is read.

The vertical scanning circuit 211 supplies the high-level post-stage reset signal rstb to the n-th row over the pulse period from timing T24 immediately after timing T23. As a result, in a case where a parasitic capacitance exists in the post-stage node 340, the history of the previous signal held in the parasitic capacitance can be erased.

The vertical scanning circuit 211 supplies the high-level selection signal Φs to the n-th row over a period from timing T25 immediately after the initialization of the post-stage node 340 to timing T27. The potential of the post-stage node 340 becomes the signal level Vsig. During exposure, the signal level is lower than the reset level, but during reading, the signal level is higher than the reset level because the post-stage node 340 is used as the reference. A difference between the reset level Vrst and the signal level Vsig corresponds to a net signal level from which reset noise and offset noise of the FD have been removed.

The DAC 213 gradually increases the ramp signal Rmp over a period from timing T26 after timing T25 to timing T27. The ADC 270 compares the ramp signal Rmp with the level Vrst′ of the vertical signal line 309, and counts a count value over a period until the comparison result is inverted. As a result, the D-phase level (signal level) is read.

Furthermore, the vertical scanning circuit 211 controls the current source transistor 316 of the n-th row to be read over a period from timing T20 to timing T27 to supply the current id1.

Furthermore, the control circuit 212 controls the load MOS transistors 251 of all the columns to supply the current id2 within the read period of all the rows.

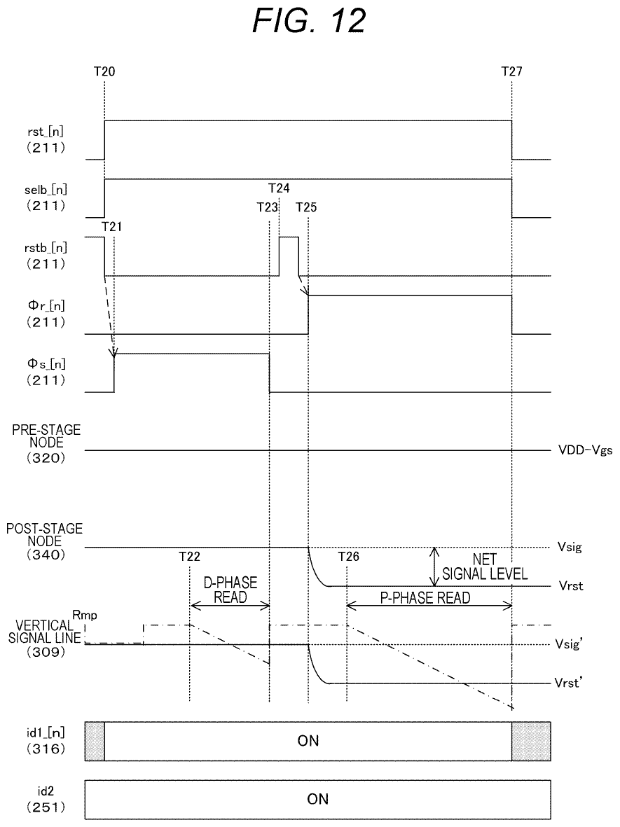

Note that the solid-state imaging element 200 reads the signal level after the reset level, but the read order is not limited to this order. Alternatively, as illustrated in FIG. 12, the solid-state imaging element 200 may read the reset level after the signal level. In this case, as illustrated in the drawing, the vertical scanning circuit 211 supplies the high-level selection signal Φr after the high-level selection signal Φs. Furthermore, in this case, it is necessary to reverse the slope of the ramp signal.

Here, an imaging system in which the pixel does not sample and hold the pixel signal, and the host 110 performs the detection processing is assumed as a first comparative example.

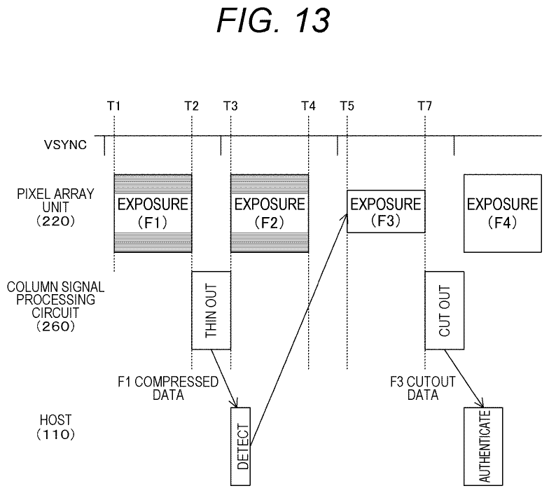

FIG. 13 is a timing chart illustrating an example of how an imaging system 100 according to the first comparative example operates. The control circuit 212 exposes only rows not to be skipped within an exposure period from timing T1 to timing T2. Then, within a read period from timing T2 to timing T3, the column signal processing circuit 260 reads columns not to be skipped to generate compressed data of the frame F1, and outputs the compressed data to the host 110.

After timing T3, the host 110 performs the detection processing on the compressed data. It is assumed that this detection processing has succeeded, and authentication is possible. Furthermore, during a period from timing T3 to timing T4, the control circuit 212 exposes only rows not to be skipped.

Then, the detection has succeeded for the first frame, so that the control circuit 212 stops thinning after timing T4, and exposes all the rows in the cutout region within an exposure period from timing T5 to timing T7. After timing T7, the column signal processing circuit 260 outputs cutout data obtained by cutting out a part of the frame F3 to the host 110, and the host 110 performs the authentication processing on the cutout data.

Next, an imaging system in which the pixel does not sample and hold the pixel signal, and the solid-state imaging element 200 outputs image data to the host 110 without compressing the image data is assumed as a second comparative example.

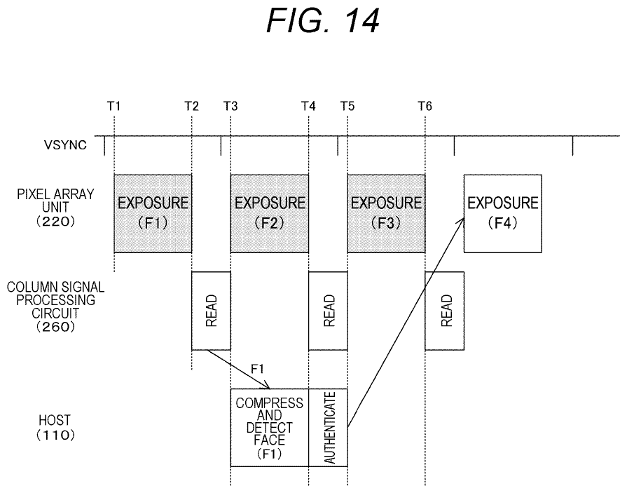

FIG. 14 is a timing chart illustrating an example of how an imaging system 100 according to the second comparative example operates. The control circuit 212 exposes all the rows within an exposure period from timing T1 to timing T2. Then, within a read period from timing T2 to timing T3, the column signal processing circuit 260 reads the frame F1 and outputs the frame F1 to the host 110.

Within a period from timing T3 to timing T4, the host 110 stores and compresses the frame F1 in the frame memory, and performs the face detection processing. Then, after timing T4, the host 110 performs the authentication processing. It is assumed that the authentication processing has failed due to reasons such as a face being obscured by reflection from another object.

Furthermore, the control circuit 212 exposes all the rows within an exposure period from timing T5 to timing T6. Then, within a read period after timing T6, the column signal processing circuit 260 reads the frame F3. The control circuit 212 changes the imaging parameter for the next frame F4 upon failure of authentication. For example, the ISO sensitivity is increased to make an image brighter.

In the first comparative example illustrated in FIG. 13, the frame F1 subject to detection and the frame F3 subject to authentication are different. Therefore, when the subject moves between the frame F1 and the frame F3, there is a possibility that an eye or the like subject to authentication falls outside the cutout region or a pattern changes due to blinking or the like.

In the second comparative example illustrated in FIG. 14, the frame F1 subject to detection and the frame F1 subject to authentication are the same. Therefore, the problem with the first comparative example is solved. All the pixels are, however, exposed to generate an uncompressed frame, which leads to an increase in the amount of data transferred between the solid-state imaging element 200 and the host 110 and an increase in power consumption. Furthermore, in a case where the authentication processing performed on the frame F1 has failed, the imaging parameter is changed after the frame F4 according to the result, and in a case where the authentication processing is performed twice or more, the throughput decreases. Even in a case where the compression and the detection processing are performed in the solid-state imaging element 200, the problem of a decrease in throughput is not solved.

On the other hand, since the configuration illustrated in FIG. 9 where the pixel samples and holds the pixel signal allows the same frame to be read a plurality of times, the frame subject to detection and the frame subject to authentication can be the same. This eliminates, when the host 110 performs intelligent authentication processing, a time lag between detection and authentication, and it is therefore possible to prevent the failure of authentication caused by an image change during the time lag.

Furthermore, since all the pixels are not read, and the compressed data or the cutout data is read instead, the amount of data and the power consumption can be reduced as compared with the second comparative example. Accordingly, the processing in the solid-state imaging element 200 can be performed faster. Furthermore, when the detection for the frame F1 fails, the imaging parameter is changed after the frame F3, which increases the throughput as compared with the second comparative example.

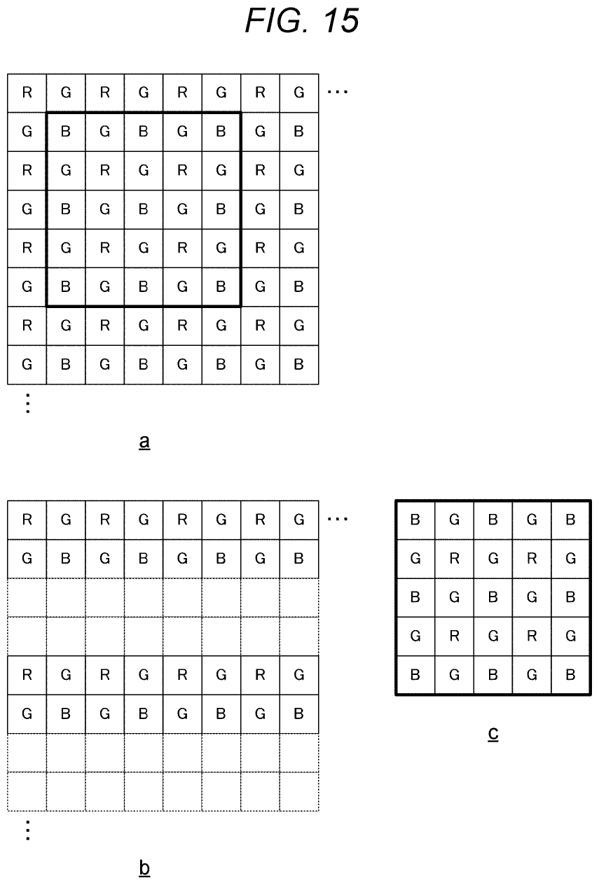

FIG. 15 is a diagram illustrating an example of image data, compressed data, and cutout data according to the first embodiment of the present technology. Of the drawing, a illustrates an example of image data before compression. Of the drawing, b illustrates an example of compressed data, and c illustrates an example of cutout data.

It is assumed that each pixel in the image data receives any one of red (R), green (G), or blue (B) light. As illustrated in a of the drawing, the pixels in the image data are arranged in a Bayer array, for example.

As illustrated in b of the drawing, data obtained by thinning out the image data on a row-by-row basis or a column-by-column basis is generated as compressed data. A dotted line in b of the drawing indicates skipped pixels.

Furthermore, a region enclosed by a bold line in a of the drawing is a cutout region. As illustrated in c of the drawing, all the pixels in the cutout region are read as cutout data. Since all the pixels in the cutout region are read, the cutout data becomes higher in resolution than the compressed data.

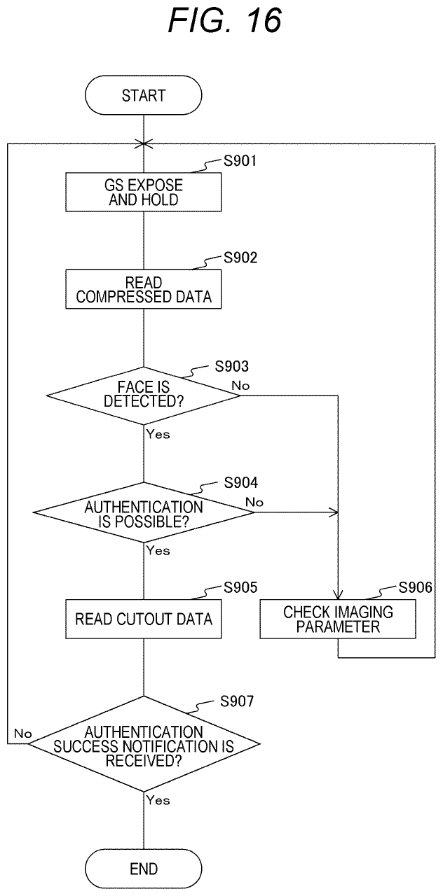

FIG. 16 is a flowchart illustrating an example of how the solid-state imaging element 200 according to the first embodiment of the present technology operates. This operation starts, for example, when a predetermined application for capturing image data is executed.

First, the solid-state imaging element 200 exposes all the pixels by the global shutter method, and holds the pixel signal for each pixel (step S901). Then, the solid-state imaging element 200 reads the compressed data (step S902), and determines whether or not a face has been detected (step S903). In a case where a face has been detected (step S903: Yes), the solid-state imaging element 200 determines whether or not authentication such as eye-based authentication is possible (step S904).

In a case where no face has been detected (step S903: No) or in a case where the authentication is not possible (step S904: No), the solid-state imaging element 200 checks the imaging parameter and changes the imaging parameter as necessary (step S906). After step S906, the solid-state imaging element 200 repeats step S901 and subsequent steps.

In a case where the authentication is possible (step S904: Yes), the solid-state imaging element 200 reads the cutout data and outputs the cutout data to the host 110 (step S905), and determines whether or not an authentication success notification has been received from the host 110 (step S907). In a case where the authentication success notification has not been received (step S907: No), the solid-state imaging element 200 repeats step S901 and subsequent steps. On the other hand, in a case where the authentication success notification has been received (step S907: Yes), the solid-state imaging element 200 terminates the imaging operation and is inactive for a certain period.

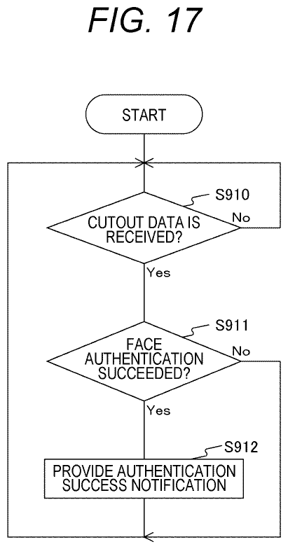

FIG. 17 is a flowchart illustrating an example of how the host 110 according to the first embodiment of the present technology operates. This operation starts, for example, when a predetermined application for capturing image data is executed.

The host 110 determines whether or not the cutout data has been received from the solid-state imaging element 200 (step S910). In a case where the cutout data has been received (step S910: Yes), the host 110 performs the authentication processing and determines whether or not the authentication processing has succeeded (step S911). In a case where the authentication processing has succeeded (step S911: Yes), the host 110 provides the authentication success notification (step S912), and repeats step S910 and subsequent steps.

In a case where no cutout data has been received (step S910: No) or in a case where the authentication processing has failed (step S911: No), the host 110 repeatedly executes step S910 and subsequent steps.

As described above, according to the first embodiment of the present technology, since the solid-state imaging element 200 outputs data cut out from the original image data on the basis of the result of the detection processing performed on the compressed data, the host 110 can perform authentication using the same image as for the detection. Accordingly, the success rate of the authentication processing increases, which allows an improvement in usability of the imaging system 100.

### 2. Second Embodiment

In the first embodiment described above, the solid-state imaging element 200 generates compressed data by thinning, but, with this configuration, it is difficult to reduce noise in the compressed data. A solid-state imaging element 200 according to this second embodiment is different from the solid-state imaging element 200 according to the first embodiment in that compressed data is generated by pixel addition.

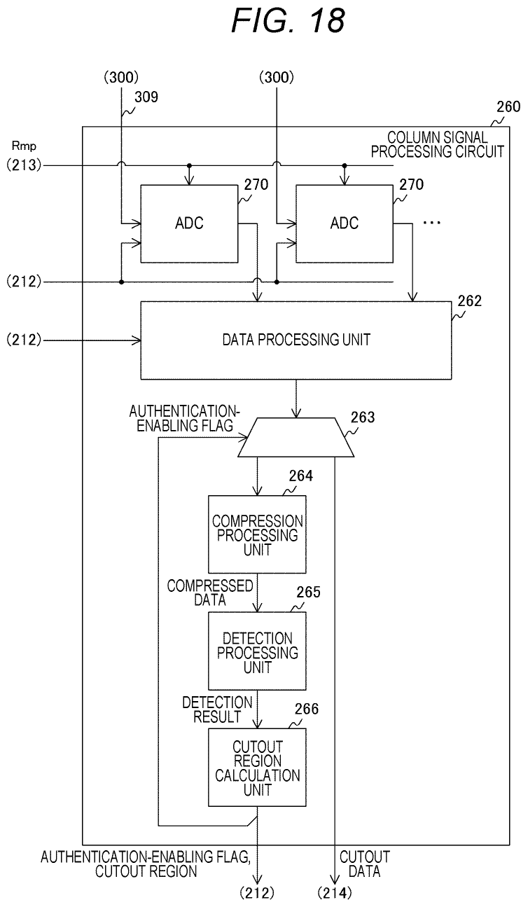

FIG. 18 is a block diagram illustrating a configuration example of a column signal processing circuit 260 according to the second embodiment of the present technology. The column signal processing circuit 260 of the second embodiment is different from the column signal processing circuit 260 of the first embodiment in that a compression processing unit 264 is further provided.

In the second embodiment, in a case where the authentication-enabling flag is “0”, the control circuit 212 controls the data processing unit 262 to perform AD conversion on all the pixels. In a case where the authentication-enabling flag is “0”, the demultiplexer 263 supplies image data received from the data processing unit 262 to the compression processing unit 264.

The compression processing unit 264 compresses the image data obtained as a result of the AD conversion by pixel addition. The compression processing unit 264 supplies compressed data generated by the compression to the detection processing unit 265.

The second embodiment is similar to the first embodiment in the operation of the column signal processing circuit 260 in a case where the authentication-enabling flag is “1”.

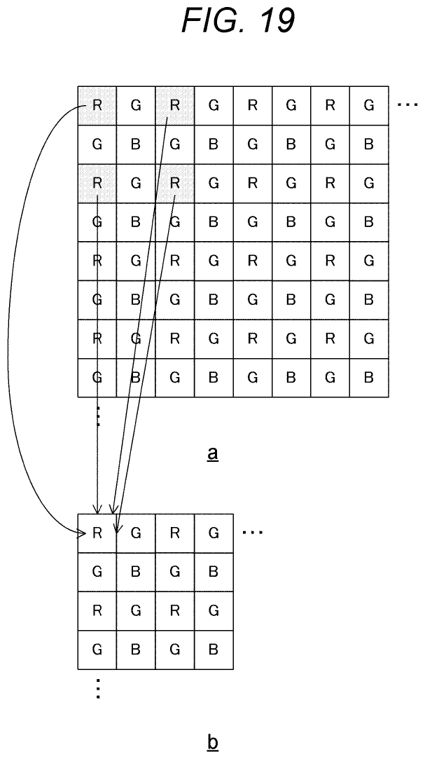

FIG. 19 is a diagram illustrating an example of image data and compressed data according to the second embodiment of the present technology. Of the drawing, a illustrates an example of image data before compression, and b illustrates an example of compressed data.

The compression processing unit 264 adds a plurality of adjacent digital pixel signals of the same color to obtain a compressed pixel signal. For example, as illustrated in a of the drawing, an average of pixel signals of four R pixels in the Bayer array is calculated. The averaged signal is arranged as a pixel signal of an R pixel in the compressed data as illustrated in b of the drawing.

As illustrated in the drawing, it is possible to reduce noise by causing the compression processing unit 264 to average a plurality of pixel signals (i.e., digital signals).

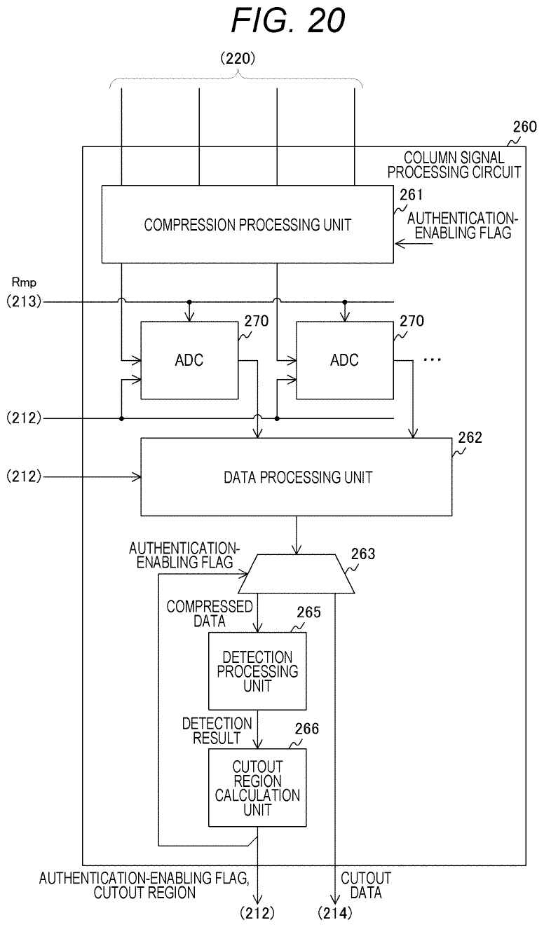

Note that although the compression processing unit 264 adds the digital signals, it is also possible to add analog pixel signals before AD conversion. In this case, as illustrated in FIG. 20, a compression processing unit 261 that adds analog pixel signals is arranged upstream of the ADC 262. As a circuit in the compression processing unit 261, for example, the circuit disclosed in FIG. 6 of Japanese Patent Application Laid-Open No. 2008-042478 is used.

As described above, according to the second embodiment of the present technology, since the compression processing unit 264 generates compressed data by adding a plurality of pixel signals, noise can be reduced as compared with the first embodiment.

### 3. Third Embodiment

In the first embodiment described above, the host 110 is activated at the start of imaging, but it is desired to further reduce the power consumption of the host 110. An imaging system 100 according to this third embodiment is different from the imaging system 100 according to the first embodiment in that the host 110 remains inactive until an eye or the like become recognizable.

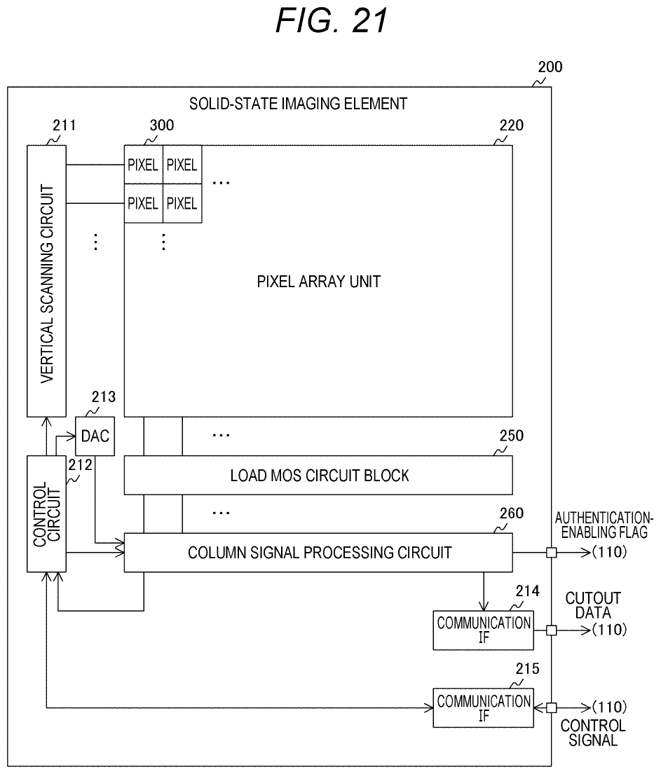

FIG. 21 is a block diagram illustrating a configuration example of a solid-state imaging element 200 according to the third embodiment of the present technology. The solid-state imaging element 200 of the third embodiment is different from the solid-state imaging element 200 of the first embodiment in that the column signal processing circuit 260 outputs the authentication-enabling flag to the host 110.

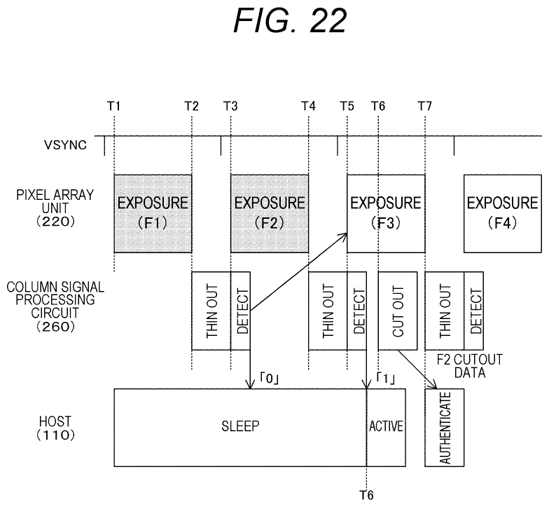

FIG. 22 is a timing chart illustrating an example of how the imaging system 100 according to the third embodiment of the present technology operates. In the initial state, the host 110 is in an inactive state. Here, the inactive state is, for example, a state where only circuits (the communication circuit, the control circuit, and the like) required for processing signals received from the solid-state imaging element 200 in the host 110 are in operation, and the other circuits (the authentication processing unit 114 and the like) are inactive.

At timing T6, the column signal processing circuit 260 transmits the authentication-enabling flag set to “1” to the host 110. In accordance with the flag, the host 110 transitions from the inactive state to an active state where the authentication processing unit 114 and the like are in operation. Then, when the cutout data is output after timing T7, the host 110 performs the authentication processing using the cutout data after timing T7.

As illustrated in the drawing, since the host 110 remains inactive until authentication becomes possible, the power consumption of the imaging system 100 can be reduced as compared with the first embodiment.

Note that the second embodiment in which pixel addition is performed can be applied to the third embodiment.

As described above, according to the third embodiment of the present technology, since the column signal processing circuit 260 outputs the authentication-enabling flag, and the host 110 remains inactive until authentication becomes possible, the power consumption of the imaging system 100 can be reduced.

### 4. Fourth Embodiment

In the first embodiment described above, the solid-state imaging element 200 performs the detection processing such as face detection, but the detection processing may be performed by the host 110 instead of the solid-state imaging element 200. An imaging system 100 according to this fourth embodiment is different from the imaging system 100 according to the first embodiment in that the host 110 performs the detection processing.

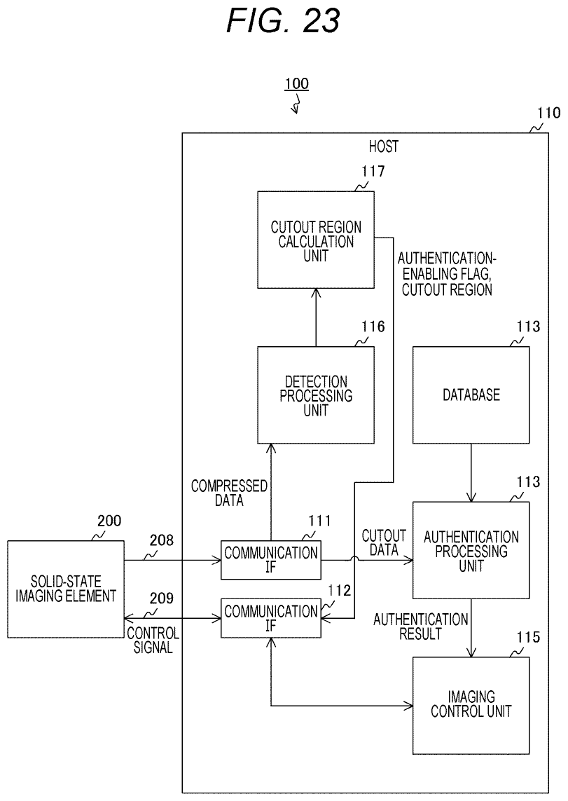

FIG. 23 is a diagram illustrating a configuration example of the imaging system 100 according to the fourth embodiment of the present technology. The imaging system 100 of the fourth embodiment is different from the imaging system 100 of the first embodiment in that the host 110 further includes a detection processing unit 116 and a cutout region calculation unit 117.

Furthermore, the solid-state imaging element 200 of the fourth embodiment is provided with neither the detection processing unit 265 nor the cutout region calculation unit 266.

The detection processing unit 116 and the cutout region calculation unit 117 are similar in configuration to the detection processing unit 265 and the cutout region calculation unit 266 in the solid-state imaging element 200, respectively. Note that the cutout region calculation unit 117 transmits the authentication-enabling flag and the cutout region to the solid-state imaging element 200 via the communication interface 112, for example.

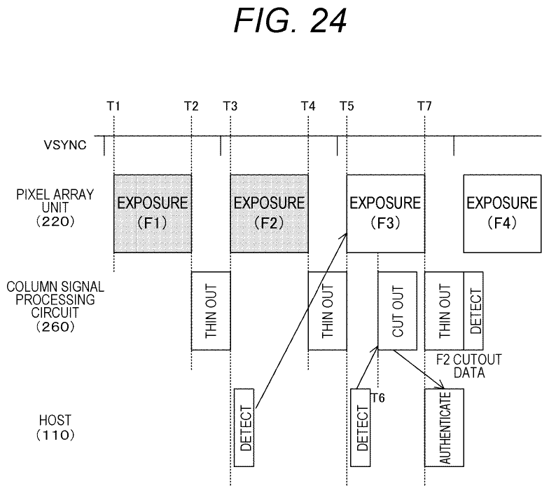

FIG. 24 is a timing chart illustrating an example of how the imaging system 100 according to the fourth embodiment of the present technology operates. Within a read period from timing T2 to timing T3, the column signal processing circuit 260 generates compressed data by thinning out the frame F1, and transmits the compressed data to the host 110.

Immediately after timing T3, the host 110 performs the detection processing on the compressed data. A slight time lag occurs between timing T3 and the start timing of the detection processing due to the transmission and reception of the compressed data. It is assumed that this detection processing has failed. In this case, the host 110 feeds back the authentication-enabling flag set to “0” to the solid-state imaging element 200.

Then, it is assumed that the host 110 performs the detection processing on the compressed data immediately after timing T5, and authentication becomes possible. The host 110 feeds back the authentication-enabling flag set to “1” and the cutout region to the solid-state imaging element 200.

The column signal processing circuit 260 outputs the cutout data after timing T6, and the host 110 performs the authentication processing using the cutout data after timing T7. As illustrated in the drawing, the host 110 further performs the detection processing, so that the processing load on the solid-state imaging element 200 can be reduced, although the feedback timing is delayed.

Note that the second embodiment in which pixel addition is performed can be applied to the fourth embodiment.

As described above, according to the fourth embodiment of the present technology, since the host 110 performs the detection processing, the processing load on the solid-state imaging element 200 can be reduced.

### 5. Fifth Embodiment

In the first embodiment described above, the host 110 performs the authentication processing such as eye-based authentication using the cutout data, but can also perform processing other than the authentication processing. An imaging system 100 according to this fifth embodiment is different from the imaging system 100 according to the first embodiment in that the solid-state imaging element 200 detects whether or not a person is present, and the host 110 performs action determination.

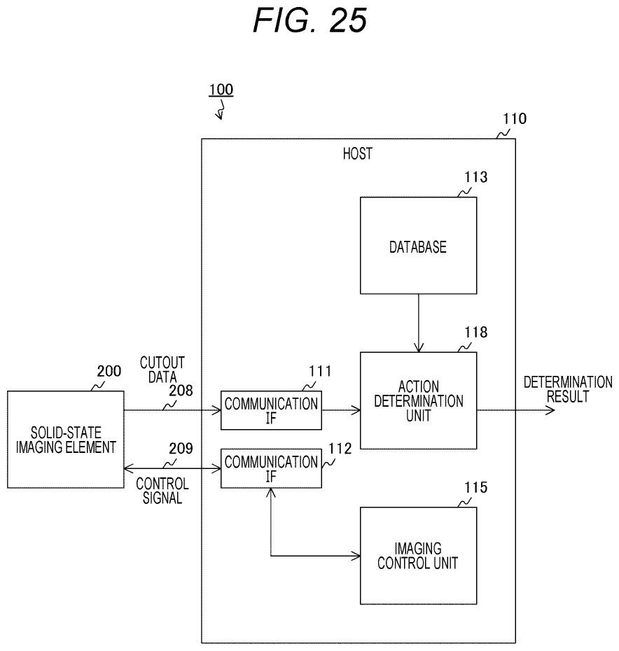

FIG. 25 is a diagram illustrating a configuration example of the imaging system 100 according to the fifth embodiment of the present technology. The imaging system 100 of the fifth embodiment is different from the imaging system 100 of the first embodiment in that the host 110 includes an action determination unit 118 instead of the authentication processing unit 114.

Furthermore, the solid-state imaging element 200 according to the fifth embodiment detects whether or not a person is present in the compressed data, and cuts out a region of the detected person from the original image data.

The action determination unit 118 analyzes the cutout data to determine whether or not the action of the person is a specific action, and outputs the determination result to the outside.

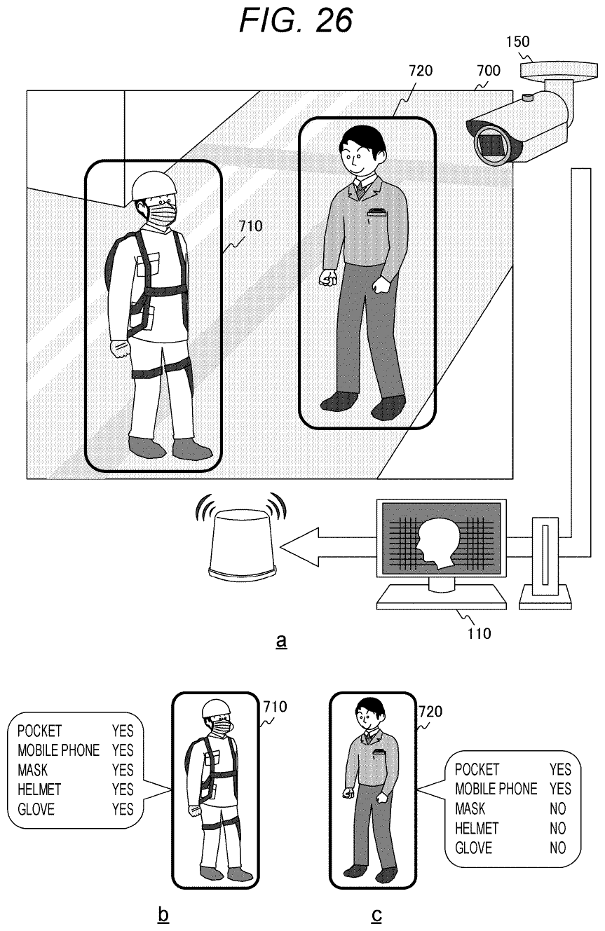

FIG. 26 is a diagram for describing a usage example of the imaging system 100 according to the fifth embodiment of the present technology. As illustrated in a of the drawing, the imaging device 150 provided with the solid-state imaging element 200 generates compressed data of image data 700. The solid-state imaging element 200 detects two persons in the compressed data, cuts out cutout regions 710 and 720 corresponding to the two persons from the original image data 700, and outputs the cutout regions to the host 110.

The host 110 analyzes the cutout regions 710 and 720 to determine whether or not the action of each person is a specific action. For example, the host 110 detects clothing and belongings of each person by object detection or the like to determine the action on the basis of such pieces of information.

For example, as illustrated in b of the drawing, the person in the detection region 710 is wearing clothes with pockets and carrying a mobile phone, and is wearing a mask, a helmet, and gloves. The host 110 determines that the person is performing tasks such as inspection work on the basis of such pieces of information.

On the other hand, as illustrated in c of the drawing, the person in the detection region 720 is wearing clothes with pockets and carrying a mobile phone, but is not wearing a mask, a helmet, or gloves. The host 110 determines that the person is performing an off-the-job action on the basis of such pieces of information.

Then, in a case where there is a person who is performing an off-the-job action, the host 110 outputs the determination result to an alarm device or the like to issue an alarm.

Note that each of the second, third, and fourth embodiments can be applied to the fifth embodiment.

As described above, according to the fifth embodiment of the present technology, since the solid-state imaging element 200 detects whether or not a person is present and the host 110 determines the action of the person, processing other than the authentication processing can be performed.

### 6. Sixth Embodiment

In the first embodiment described above, the host 110 performs the authentication processing such as eye-based authentication using the cutout data, but can also perform processing other than the authentication processing. An imaging system 100 according to this sixth embodiment is different from the imaging system 100 according to the first embodiment in that the solid-state imaging element 200 detects a difference from background data, and the host 110 stores cutout data.

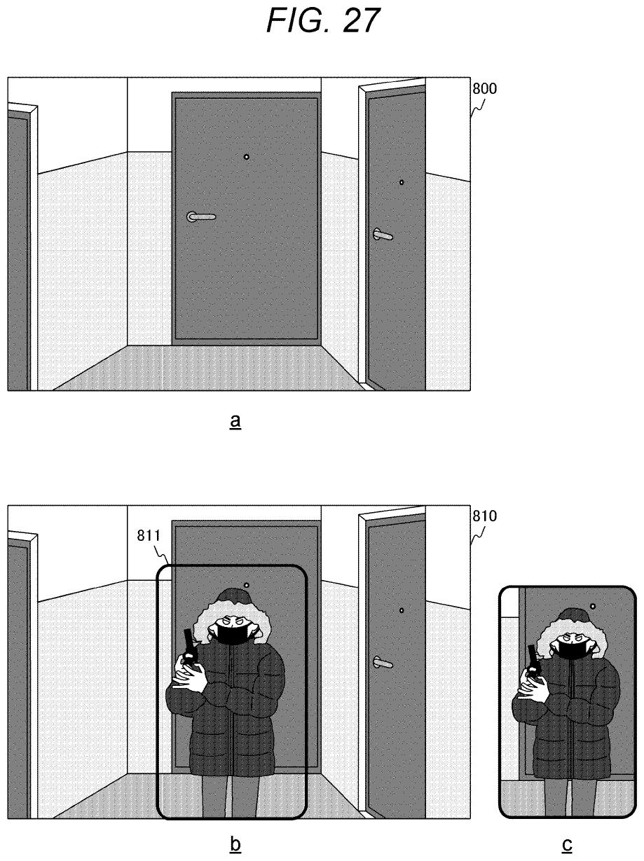

FIG. 27 is a diagram illustrating examples of background data, compressed data, and cutout data according to the sixth embodiment of the present technology. Of the drawing, a illustrates an example of background data 800. Of the drawing, b illustrates an example of compressed data 810. Of the drawing, c illustrates an example of cutout data.

The detection processing unit 265 in the solid-state imaging element 200 detects a difference between the background data 800 and the compressed data 810, and sets a region corresponding to the difference as a cutout region 811. Then, the control circuit 212 outputs cutout data obtained by cutting out the cutout region 811 from the original image data.

The host 110 stores the cutout data. Alternatively, the host 110 analyzes the cutout data to determine whether or not an abnormality is present.

Since the background subtraction method is simpler than the detection processing such as face detection in the solid-state imaging element 200, the use of the background subtraction method allows a reduction in the processing load on the solid-state imaging element 200.

Note that each of the second to fifth embodiments can be applied to the sixth embodiment.

As described above, according to the sixth embodiment of the present technology, since the solid-state imaging element 200 detects a difference from the background, the processing load can be reduced.

### First Modification Example

In the first embodiment described above, the pre-stage circuit 310 reads a signal with the pre-stage circuit 310 connected to the pre-stage node 320, but this configuration cannot block noise from the pre-stage node 320 during reading. A pixel 300 of this first modification example of the first embodiment is different from the pixel 300 of the first embodiment in that a transistor is provided between the pre-stage circuit 310 and the pre-stage node 320.

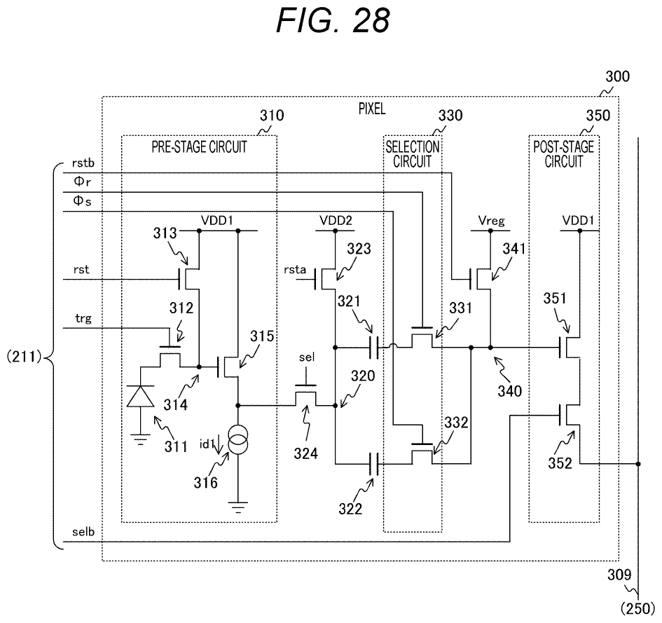

FIG. 28 is a circuit diagram illustrating a configuration example of the pixel 300 according to the first modification example of the first embodiment of the present technology. The pixel 300 of this first modification example of the first embodiment is different from the pixel 300 of the first embodiment in that a pre-stage reset transistor 323 and a pre-stage selection transistor 324 are further provided.

Furthermore, the power supply voltage for the pre-stage circuit 310 and the post-stage circuit 350 of the first modification example of the first embodiment is denoted as VDD1.

The pre-stage reset transistor 323 initializes the level of the pre-stage node 320 with a power supply voltage VDD2. It is desirable that the power supply voltage VDD2 be set to a value satisfying the following expression.

$$VDD 2 = VDD 1 - Vgs \qquad Expression 1$$

In the above expression, Vgs represents a gate-source voltage of the pre-stage amplification transistor 315.

Setting to the value satisfying Expression 1 allow a reduction in fluctuations in potential between the pre-stage node 320 and the post-stage node 340 in the dark. It is therefore possible to improve photo response non-uniformity (PRNU).

The pre-stage selection transistor 324 opens and closes a path between the pre-stage circuit 310 and the pre-stage node 320 in accordance with a pre-stage selection signal sel received from the vertical scanning circuit 211.

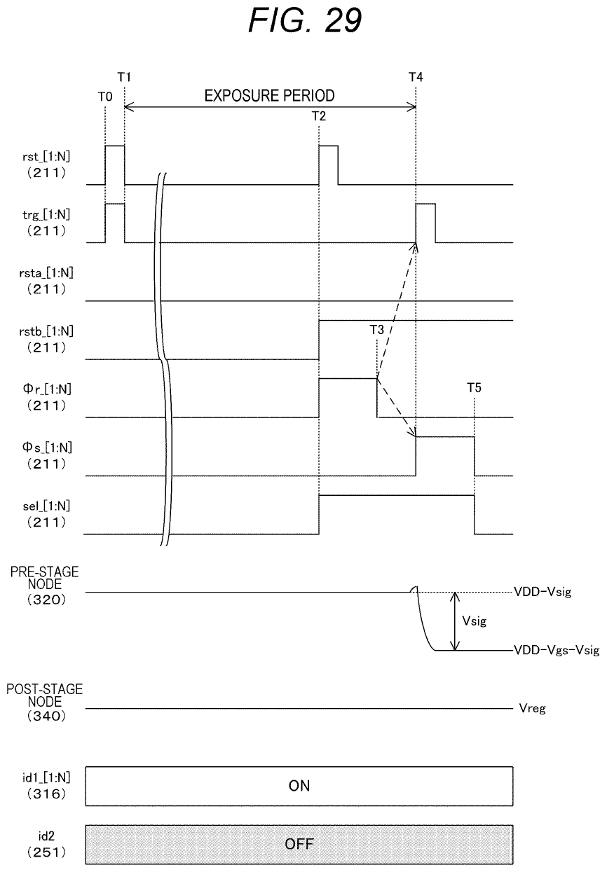

FIG. 29 is a timing chart illustrating an example of a global shutter operation according to the first modification example of the first embodiment of the present technology. The timing chart of the first modification example of the first embodiment is different from the timing chart of the first embodiment in that the vertical scanning circuit 211 further supplies a pre-stage reset signal rsta and the pre-stage selection signal sel. In the drawing, rsta_[n] and sel_[n] represent signals to the pixels in the n-th row.

The vertical scanning circuit 211 supplies a high-level pre-stage selection signal sel to all the pixels over a period from timing T2 immediately before the end of exposure to timing T5. The pre-stage reset signal rsta is controlled to the low level.

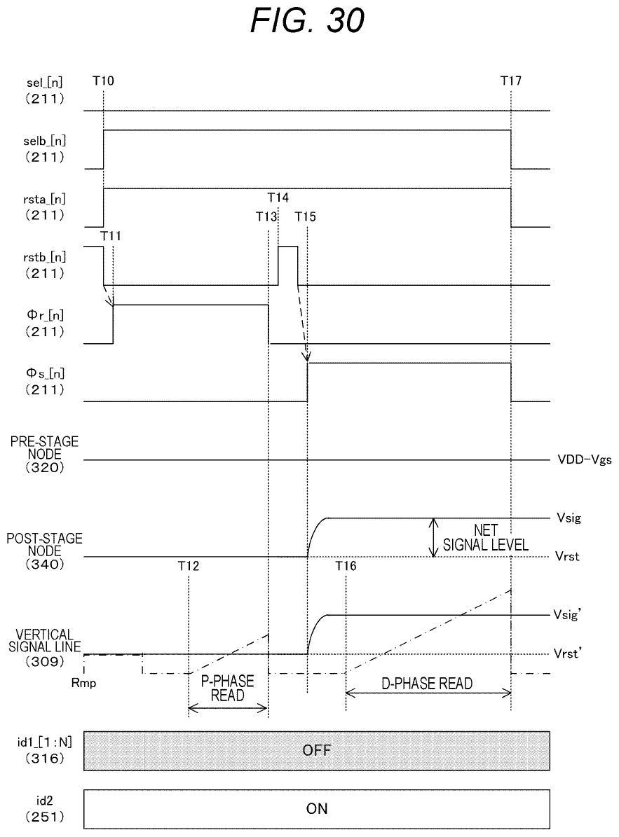

FIG. 30 is a timing chart illustrating an example of a read operation according to the first modification example of the first embodiment of the present technology. During reading of each row, the pre-stage selection signal sel is controlled to the low level. This control brings the pre-stage selection transistor 324 into the open state to disconnect the pre-stage node 320 from the pre-stage circuit 310. It is therefore possible to block noise from the pre-stage node 320 during reading.

Furthermore, during a read period of the n-th row from timing T10 to timing T17, the vertical scanning circuit 211 supplies a high-level pre-stage reset signal rsta to the n-th row.

Furthermore, during reading, the vertical scanning circuit 211 controls the current source transistors 316 of all the pixels to interrupt the supply of the current id1. The current id2 is supplied in a manner similar to the current id2 in the first embodiment. Thus, the control of the current id1 is simplified as compared with the first embodiment.

As described above, according to the first modification example of the first embodiment of the present technology, since the pre-stage selection transistor 324 transitions to the open state at the time of reading to disconnect the pre-stage circuit 310 from the pre-stage node 320, it is possible to block noise from the pre-stage circuit 310.

### Second Modification Example

In the first embodiment described above, the circuits in the solid-state imaging element 200 are provided in a single semiconductor chip, but there is a possibility that this configuration prevents the elements from fitting in the semiconductor chip in a case where the pixel 300 is miniaturized. A solid-state imaging element 200 of this second modification example of the first embodiment is different from the solid-state imaging element 200 of the first embodiment in that the circuits in the solid-state imaging element 200 are dispersedly arranged in two semiconductor chips.

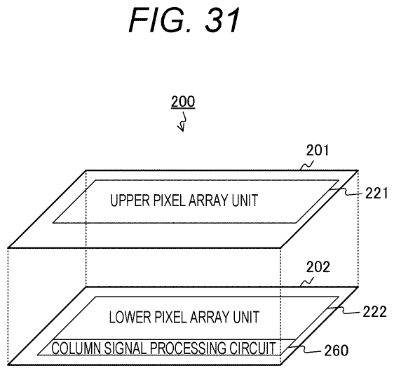

FIG. 31 is a diagram illustrating an example of a multilayer structure of the solid-state imaging element 200 according to the second modification example of the first embodiment of the present technology. The solid-state imaging element 200 of the second modification example of the first embodiment includes a circuit chip 202 and a pixel chip 201 stacked on the circuit chip 202. These chips are electrically connected by, for example, Cu—Cu bonding. Note that the connection can be made not only by Cu—Cu bonding but also a via or a bump.

The pixel chip 201 is provided with an upper pixel array unit 221. The circuit chip 202 is provided with a lower pixel array unit 222 and the column signal processing circuit 260. As for each pixel in the pixel array unit 220, part of the pixel is arranged in the upper pixel array unit 221, and the rest of the pixel is arranged in the lower pixel array unit 222.

Furthermore, the circuit chip 202 is further provided with the vertical scanning circuit 211, the control circuit 212, the DAC 213, and the load MOS circuit block 250. These circuits are not illustrated in the drawing.

Furthermore, the pixel chip 201 is manufactured, for example, by a pixel-dedicated process, and the circuit chip 202 is manufactured, for example, by a complementary MOS (CMOS) process. Note that the pixel chip 201 is an example of a first chip described in the claims, and the circuit chip 202 is an example of a second chip described in the claims.

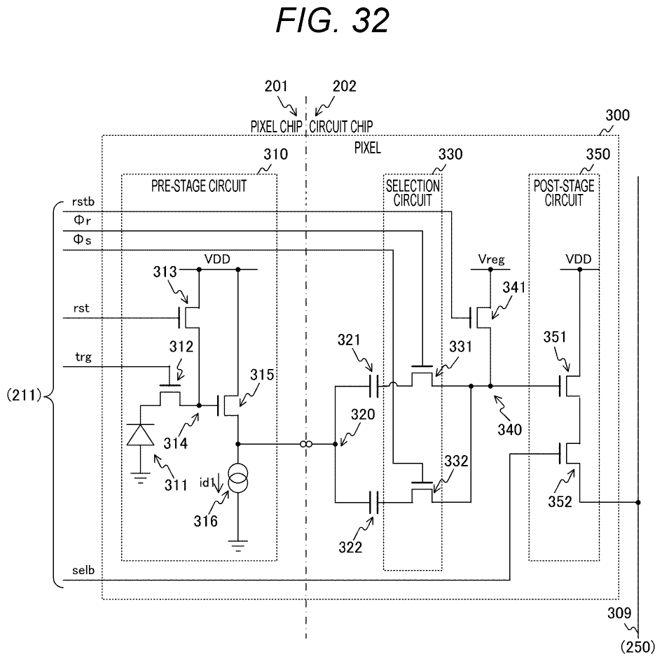

FIG. 32 is a circuit diagram illustrating a configuration example of the pixel 300 according to the second modification example of the first embodiment of the present technology. In the pixel 300, the pre-stage circuit 310 is arranged in the pixel chip 201, and other circuits and elements (such as the capacitor elements 321 to 322) are arranged in the circuit chip 202. Note that the current source transistors 316 can be further arranged in the circuit chip 202. As illustrated in the drawing, dispersedly arranging the elements belonging to the pixel 300 in the pixel chip 201 and the circuit chip 202 stacked on top of each other allows a reduction in pixel area, thereby facilitating pixel miniaturization.

As described above, according to the second modification example of the first embodiment of the present technology, the circuits and elements belonging to the pixel 300 are dispersedly arranged in the two semiconductor chips to facilitate pixel miniaturization.

### Third Modification Example

In the second modification example of the first embodiment described above, the lower circuit chip 202 is provided with part of the pixel 300 and the peripheral circuits (such as the column signal processing circuit 260). This configuration, however, makes the arrangement area of the circuits and elements belonging to the circuit chip 202 larger than the arrangement area of the pixel chip 201 by the peripheral circuits, and there is a possibility that an unnecessary space without circuits and elements is generated in the pixel chip 201. The solid-state imaging element 200 of the third modification example of the first embodiment is different from the solid-state imaging element 200 of the second modification example of the first embodiment in that the circuits belonging to the solid-state imaging element 200 are dispersedly arranged in three semiconductor chips.

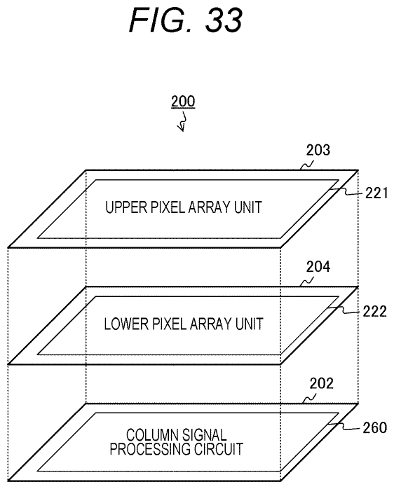

FIG. 33 is a diagram illustrating an example of a multilayer structure of the solid-state imaging element 200 according to the third modification example of the first embodiment of the present technology. The solid-state imaging element 200 according to the third modification example of the first embodiment includes an upper pixel chip 203, a lower pixel chip 204, and a circuit chip 202. These chips are stacked, and are electrically connected by, for example, Cu—Cu bonding. Note that the connection can be made not only by Cu—Cu bonding but also a via or a bump.

The upper pixel chip 203 is provided with the upper pixel array unit 221. The lower pixel chip 204 is provided with the lower pixel array unit 222. As for each pixel in the pixel array unit 220, part of the pixel is arranged in the upper pixel array unit 221, and the rest of the pixel is arranged in the lower pixel array unit 222.

Furthermore, the circuit chip 202 is provided with the column signal processing circuit 260, the vertical scanning circuit 211, the control circuit 212, the DAC 213, and the load MOS circuit block 250. Circuits other than the column signal processing circuit 260 are not illustrated in the drawing.

Note that the upper pixel chip 203 is an example of the first chip described in the claims, and the lower pixel chip 204 is an example of the second chip described in the claims. The circuit chip 202 is an example of a third chip described in the claims.

Such a three-layer configuration as illustrated in the drawing allows a reduction in unnecessary space and allows further pixel miniaturization as compared with a two-layer configuration. Furthermore, the lower pixel chip 204 that is a second layer can be manufactured by a dedicated process for capacitors and switches.

As described above, in the third modification example of the first embodiment of the present technology, since the circuits belonging to the solid-state imaging element 200 are dispersedly arranged in the three semiconductor chips, the pixels can be further miniaturized as compared with a case where the circuits are dispersedly arranged in the two semiconductor chips.

### 7. Seventh Embodiment

In the first embodiment described above, the reset level is sampled and held during the exposure period, but this configuration prevents the exposure period from being shorter than the sample and hold period of the reset level. A solid-state imaging element 200 of this seventh embodiment is different from the solid-state imaging element 200 of the first embodiment in that a transistor that discharges charges from a photoelectric conversion element is added to make the exposure period shorter.

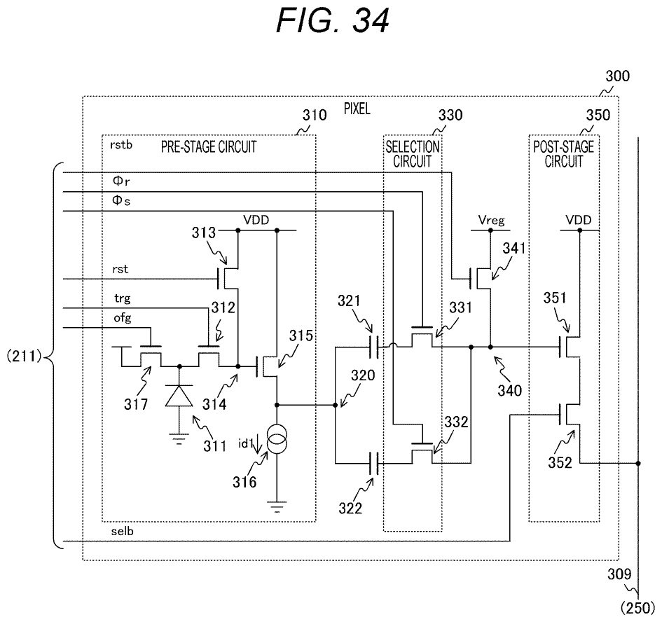

FIG. 34 is a circuit diagram illustrating a configuration example of the pixel 300 according to the seventh embodiment of the present technology. The pixel 300 of the seventh embodiment is different from the pixel 300 of the first embodiment in that the pixel 300 further includes a discharge transistor 317 in the pre-stage circuit 310.

The discharge transistor 317 functions as an overflow drain that discharges charges from the photoelectric conversion element 311 in accordance with a discharge signal ofg received from the vertical scanning circuit 211. As the discharge transistor 317, for example, an nMOS transistors is used.

The configuration without the discharge transistor 317 as in the first embodiment may suffer blooming when charges are transferred from the photoelectric conversion element 311 to the FD 314 for all the pixels. Then, at the time of FD reset, the potential of the FD 314 and the potential of the pre-stage node 320 drop. In response to the potential drop, charging and discharging currents of the capacitor elements 321 and 322 continue to occur, and IR drop in the power supply or the ground changes from a steady state without blooming.

On the other hand, at the time of sampling and holding the signal levels of all the pixels, after the transfer of signal charges, the photoelectric conversion element 311 has no charge, so that blooming does not occur, and IR drop in the power supply or the ground goes into the steady state without blooming. Due to a difference between IR drop at the time of sampling and holding the reset level and IR drop at the time of sampling and holding the signal level, streaking noise occurs.

In the seventh embodiment in which the discharge transistor 317 is provided, on the other hand, the charges in the photoelectric conversion element 311 are discharged toward the overflow drain. Therefore, IR drop at the time of sampling and holding the reset level and IR drop at the time of sampling and holding the signal level become almost identical to each other, so that it is possible to suppress streaking noise.

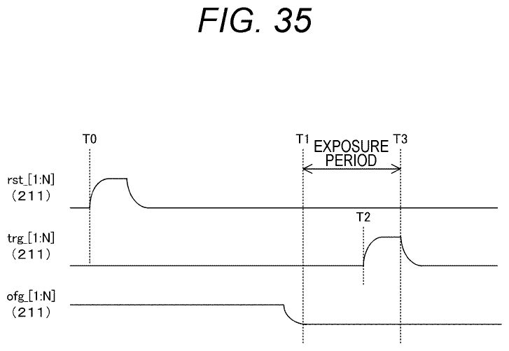

FIG. 35 is a timing chart illustrating an example of a global shutter operation according to the seventh embodiment of the present technology. At timing T0 before the start of exposure, the vertical scanning circuit 211 supplies the high-level FD reset signal rst to all the pixels over the pulse period with the discharge signal ofg set to the high level for all the pixels. As a result, all the pixels are PD reset and FD reset. Furthermore, the reset level is sampled and held. Here, ofg_[n] in the drawing represents signals to the pixels in the n-th row of the N rows.

Then, at timing T1 that is the start of exposure, the vertical scanning circuit 211 returns the discharge signal ofg to the low level for all the pixels. The vertical scanning circuit 211 then supplies the high-level transfer signal trg to all the pixels over a period from timing T2 immediately before the end of exposure to timing T3 at the end of exposure. As a result, the signal level is sampled and held.

The configuration without the discharge transistor 317 as in the first embodiment needs to bring both the transfer transistor 312 and the FD reset transistor 313 into the on-state at the start of exposure (i.e., at the time of PD reset). With this control, at the time of PD reset, the FD 314 also needs to be reset at the same time. It is therefore necessary to perform the FD reset again within the exposure period to sample and hold the reset level, so that the exposure period cannot be made shorter than the sample and hold period of the reset level. When the reset levels of all the pixels are sampled and held, a certain waiting time is required until the voltage or the current settle, and for example, a sample and hold period of several microseconds (μs) to several tens of microseconds (μs) is required.

On the other hand, in the seventh embodiment in which the discharge transistor 317 is provided, the PD reset and the FD reset can be separately performed. Accordingly, as illustrated in the drawing, it is possible to sample and hold the reset level by performing the FD reset before cancellation of the PD reset (the start of exposure). It is therefore possible to make the exposure period shorter than the sample and hold period of the reset level.

Note that the first to third modification examples of the first embodiment, and the second to sixth embodiments can also be applied to the seventh embodiment.

As described above, according to the seventh embodiment of the present technology, since the discharge transistor 317 that discharges charges from the photoelectric conversion element 311 is provided, it is possible to sample and hold the reset level by performing the FD reset before the start of exposure. It is therefore possible to make the exposure period shorter than the sample and hold period of the reset level.

### 8. Eighth Embodiment

In the first embodiment described above, the FD 314 is initialized with the power supply voltage VDD, but there is a possibility that this configuration causes deterioration of photo response non-uniformity (PRNU) due to variations of the capacitor elements 321 and 322 or parasitic capacitance. A solid-state imaging element 200 of this eighth embodiment is different from the solid-state imaging element 200 of the first embodiment in that PRNU is improved by decreasing the power supply for the FD reset transistor 313 during reading.

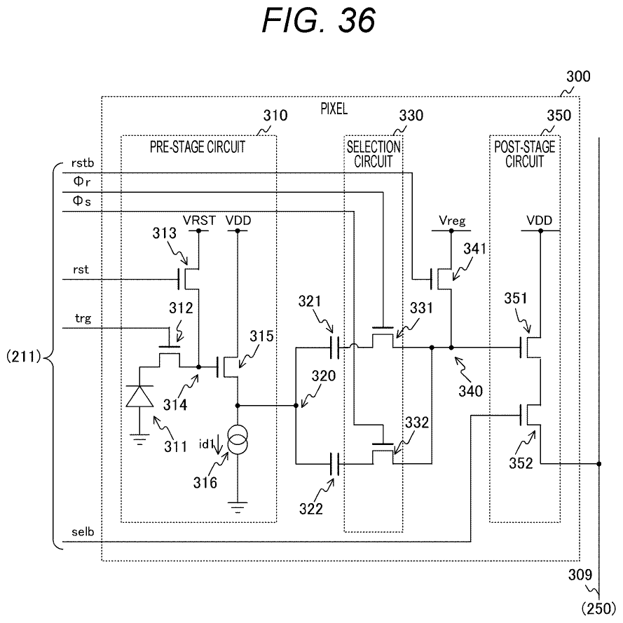

FIG. 36 is a circuit diagram illustrating a configuration example of the pixel 300 according to the eighth embodiment of the present technology. The pixel 300 of the eighth embodiment is different from the pixel 300 of the first embodiment in that the power supply for the FD reset transistor 313 is separated from the power supply voltage VDD for the pixel 300.

The FD reset transistor 313 of the third embodiment has a drain connected to a reset power supply voltage VRST. The reset power supply voltage VRST is controlled by, for example, the control circuit 212.

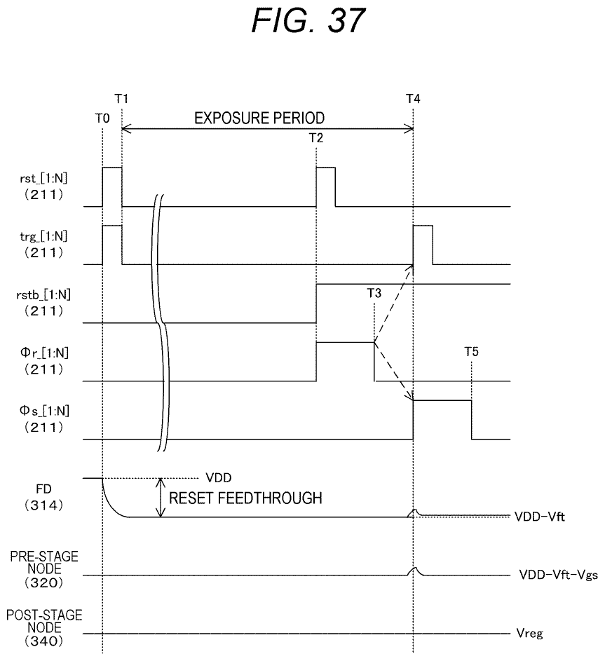

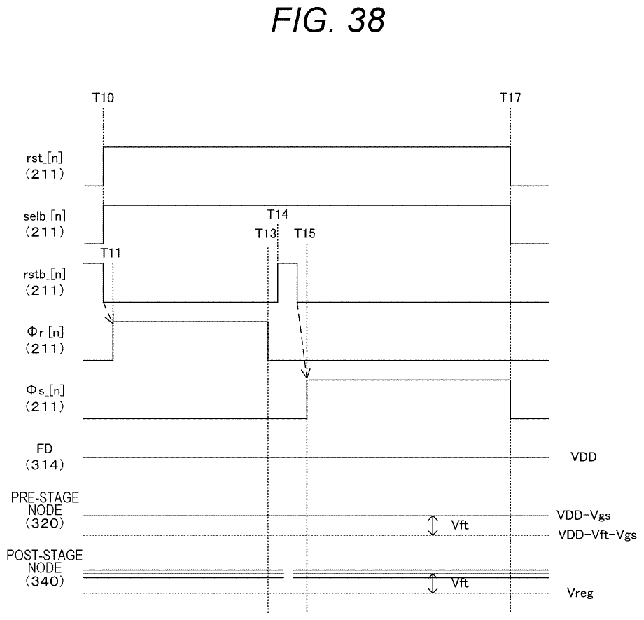

Here, consider deterioration of PRNU in the pixel 300 of the first embodiment with reference to FIGS. 37 and 38. In the first embodiment, as illustrated in FIG. 37, at timing T0 immediately before the start of exposure, the potential of the FD 314 drops due to reset feedthrough of the FD reset transistor 313. This fluctuation is denoted as Vft.

In the first embodiment, since the power supply voltage for the FD reset transistor 313 is VDD, the potential of the FD 314 fluctuates from VDD to VDD-Vft at timing T0. Furthermore, the potential of the pre-stage node 320 during exposure becomes equal to VDD-Vft-Vgs.

Furthermore, in the first embodiment, as illustrated in FIG. 38, the FD reset transistor 313 transitions to the on-state at the time of reading to clamp the FD 314 to the power supply voltage VDD. The potential of the pre-stage node 320 and the potential of the post-stage node 340 at the time of reading are shifted higher by about the fluctuation Vft of the FD 314. However, due to variations in capacitance values of the capacitor elements 321 and 322 or parasitic capacitance, the shift voltage amount varies for each pixel, which causes deterioration of PRNU.

The amount of transition of the post-stage node 340 in a case where the pre-stage node 320 transitions by Vft is expressed by, for example, the following expression.

$$\{ ( C s + δ Cs ) / ( Cs + δ Cs + Cp ) \} ⋆ Vft \qquad Expression 2$$

In the above expression, Cs represents a capacitance value of the capacitor element 322 on the signal level side, and δCs represents a variation in Cs. Cp is a capacitance value of the parasitic capacitance of the post-stage node 340.

Expression 2 can be approximated by the following expression.

$$\{ 1 - ( δ Cs / Cs ) * ( Cp / Cs ) \} * Vft \qquad Expression 3$$

From Expression 3, the variations of the post-stage node 340 can be expressed by the following expression.

$$\{ ( δ Cs / Cs ) * ( Cp / Cs ) \} ⋆ Vft \qquad Expression 4$$

With (δCs/Cs) set to 10-2, (Cp/Cs) set to 10-1, and Vft set to 400 millivolts (mV), the PRNU is 400 μVrms according to Expression 4, which is a relatively large value.

In particular, in order to reduce kTC noise during sampling and holding input conversion capacitance, it is necessary to increase a charge-voltage conversion efficiency of the FD 314. In order to increase the charge-voltage conversion efficiency, it is necessary to reduce the capacitance of the FD 314, but the smaller the capacitance of the FD 314, the larger the fluctuation Vft, which may be several hundred millivolts (mV). In this case, PRNU impact may be non-negligible according to Expression 4.

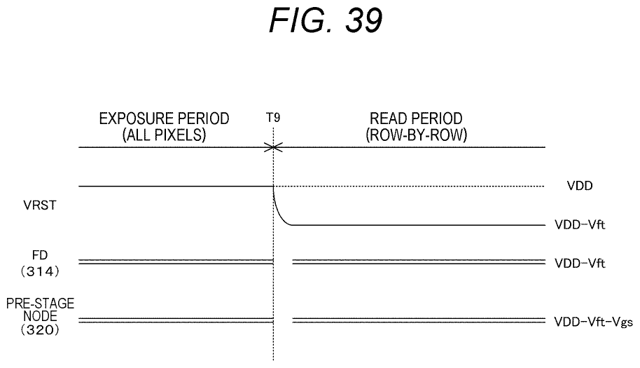

FIG. 39 is a timing chart illustrating an example of voltage control according to the eighth embodiment of the present technology.

During the row reading period after the timing T9, the control circuit 212 controls the reset power supply voltage VRST to a value different from that in the exposure period.

For example, during the exposure period, the control circuit 212 makes the reset power supply voltage VRST identical to the power supply voltage VDD. During the read period, on the other hand, the control circuit 212 lowers the reset power supply voltage VRST to VDD-Vft. That is, during the read period, the control circuit 212 lowers the reset power supply voltage VRST by an amount almost equal to the fluctuation Vft caused by reset feedthrough. Through this control, the reset level of the FD 314 can be equalized between the exposure period and the read period.

It is possible to reduce, by controlling the reset power supply voltage VRST, the voltage fluctuation between the FD 314 and the pre-stage node 320, as illustrated in the drawing. It is therefore possible to suppress variations of the capacitor elements 321 and 322 and deterioration of PRNU due to parasitic capacitance.

Note that the first to third modification examples of the first embodiment, and the second to seventh embodiments can also be applied to the eighth embodiment.

As described above, according to the eighth embodiment of the present technology, since the control circuit 212 lowers the reset power supply voltage VRST by the fluctuation Vft caused by reset feedthrough at the time of reading, it is possible to equalize the reset level between the exposure period and the read period. It is therefore possible to suppress deterioration of photo response non-uniformity (PRNU).

### 9. Ninth Embodiment

In the first embodiment described above, the reset level and the signal level are read in this order for each frame, but there is a possibility that this configuration causes deterioration of photo response non-uniformity (PRNU) due to variations of the capacitor elements 321 and 322 or parasitic capacitance. A solid-state imaging element 200 of this ninth embodiment is different from the solid-state imaging element 200 of the first embodiment in that PRNU is improved by switching between the level held in the capacitor element 321 and the level held in the capacitor element 322 for each frame.

The solid-state imaging element 200 of the ninth embodiment continuously captures a plurality of frames in synchronization with the vertical synchronization signal. An odd-numbered frame is referred to as “odd frame”, and an even-numbered frame is referred to as “even frame”.

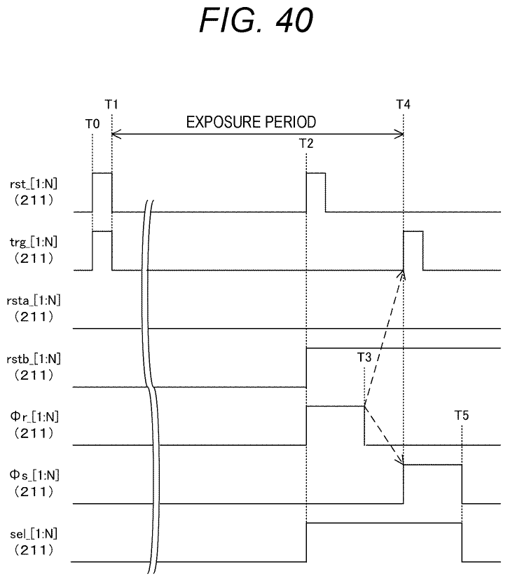

FIG. 40 is a timing chart illustrating an example of a global shutter operation for odd frames according to the ninth embodiment. Within the exposure period for each odd frame, the pre-stage circuit 310 in the solid-state imaging element 200 sets the selection signal Φr and the selection signal Φs to the high level in this order to cause the capacitor element 321 to hold the reset level first and then cause the capacitor element 322 to hold the signal level.

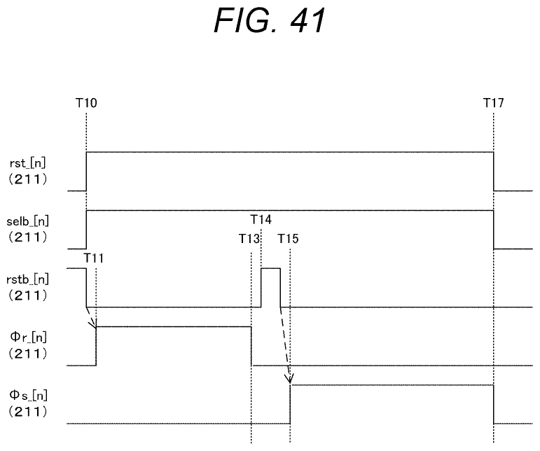

FIG. 41 is a timing chart illustrating an example of a read operation for odd frames according to the ninth embodiment of the present technology. Within the read period for each odd frame, the post-stage circuit 350 in the solid-state imaging element 200 sets the selection signal Φr and the selection signal Φs to the high level in this order to read the reset level first and then read the signal level.

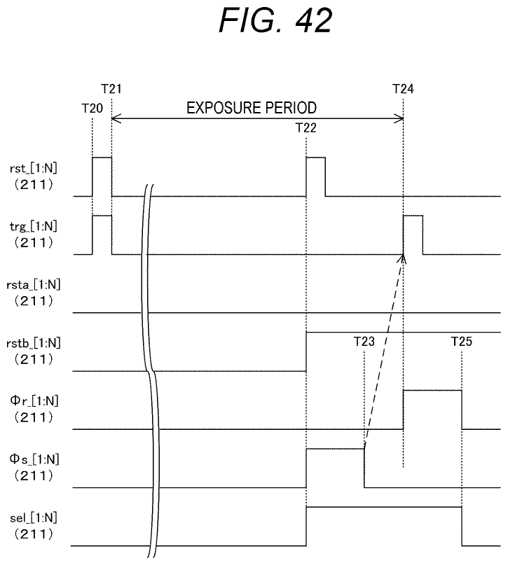

FIG. 42 is a timing chart illustrating an example of a global shutter operation for even frames according to the ninth embodiment of the present technology. Within the exposure period for each even frame, the pre-stage circuit 310 in the solid-state imaging element 200 sets the selection signal Φs and the selection signal Φr to the high level in this order to cause the capacitor element 322 to hold the reset level first and then cause the capacitor element 321 to hold the signal level.

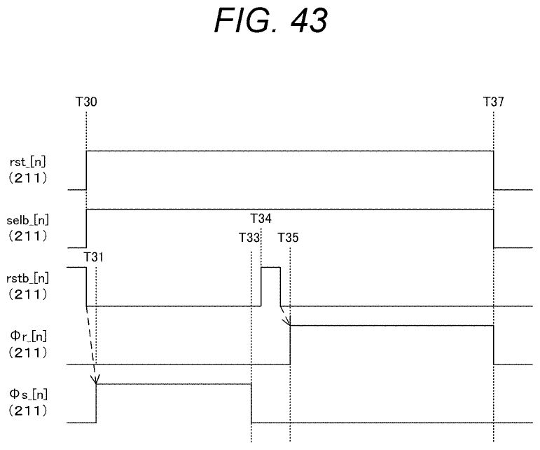

FIG. 43 is a timing chart illustrating an example of a read operation for even frames according to the ninth embodiment of the present technology. Within the read period for each even frame, the post-stage circuit 350 in the solid-state imaging element 200 sets the selection signal Φs and the selection signal Φr to the high level in this order to read the reset level first and then read the signal level.

As illustrated in FIGS. 40 and 42, the levels held in the capacitor elements 321 and 322 are reversed between the even frames and the odd frames. This also reverses the polarity of PRNU between the even frames and the odd frames. The column signal processing circuit 260 in the subsequent stage obtains an average of the odd frames and the even frames. It is therefore possible to cancel out PRNU with opposite polarities.

This control is effective in capturing a moving image or adding frames. Furthermore, there is no need to add any element to the pixels 300, and this control can be achieved only by changing the drive system.

Note that the first to third modification examples of the first embodiment, and the second to eighth embodiments can also be applied to the ninth embodiment.

As described above, in the ninth embodiment of the present technology, since the level held in the capacitor element 321 and the level held in the capacitor element 322 are reversed between the odd frames and the even frames, the polarity of PRNU can be reversed between the odd frames and the even frames. The column signal processing circuit 260 adds the odd frames and the even frames, so that deterioration of the PRNU can be suppressed.

### 10. Tenth Embodiment

In the first embodiment described above, the column signal processing circuit 260 obtains a difference between the reset level and the signal level for each column. With this configuration, however, there is a possibility that, when light with very high intensity is incident on a pixel, a black spot phenomenon in which black spots appear occurs due to a luminance drop caused by overflow of charges from the photoelectric conversion element 311. A solid-state imaging element 200 of this tenth embodiment is different from the solid-state imaging element 200 of the first embodiment in determining whether or not the black spot phenomenon has occurred for each pixel.

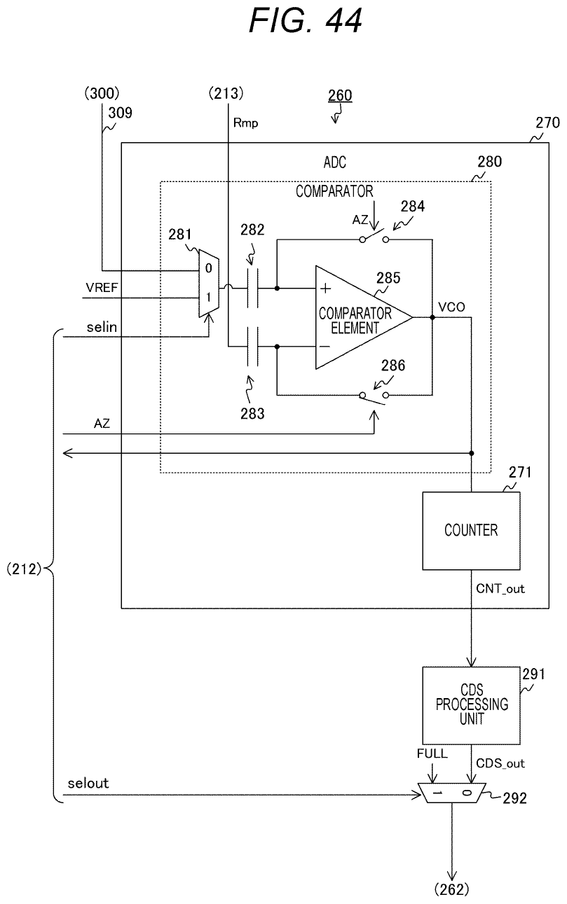

FIG. 44 is a circuit diagram illustrating a configuration example of the column signal processing circuit 260 according to the tenth embodiment of the present technology. The column signal processing circuit 260 of this fifth embodiment is further provided with a plurality of CDS processing units 291 and a plurality of selectors 292. The ADC 270, the CDS processing unit 291, and the selector 292 are provided for each column.

Furthermore, the ADC 270 includes a comparator 280 and a counter 271. The comparator 280 compares the level of the vertical signal line 309 with the ramp signal Rmp received from the DAC 213, and outputs a comparison result VCO. The comparison result VCO is supplied to the counter 271 and the control circuit 212. The comparator 280 includes a selector 281, capacitor elements 282 and 283, auto-zero switches 284 and 286, and a comparator element 285.

The selector 281 connects either the vertical signal line 309 of the corresponding column or a node of a predetermined reference voltage VREF to a non-inverting input terminal (+) of the comparator element 285 via the capacitor element 282 in accordance with an input-side selection signal selin. The input-side selection signal selin is supplied from the control circuit 212.

The comparator element 285 compares the level of the non-inverting input terminal (+) with the level of an inverting input terminal (−), and outputs the comparison result VCO to the counter 271. The ramp signal Rmp is input to the inverting input terminal (−) via the capacitor element 283.

The auto-zero switch 284 short-circuits the non-inverting input terminal (+) and an output terminal of the comparison result VCO in accordance with an auto-zero signal AZ received from the control circuit 212. The auto-zero switch 286 short-circuits the inverting input terminal (−) and the output terminal of the comparison result VCO in accordance with the auto-zero signal Az.

The counter 271 counts a count value over a period until the comparison result VCO is inverted, and outputs a digital signal CNT_out indicating the count value to the CDS processing unit 291.

The CDS processing unit 291 performs CDS processing on the digital signal CNT_out. The CDS processing unit 291 calculates a difference between the digital signal CNT_out corresponding to the reset level and the digital signal CNT_out corresponding to the signal level, and outputs the difference as CDS_out to the selector 292.

The selector 292 outputs, in accordance with an output-side selection signal selout received from the control circuit 212, either the digital signal CDS_out subjected to the CDS processing or a full-code digital signal FULL to the data processing unit 262 as pixel data of the corresponding column.

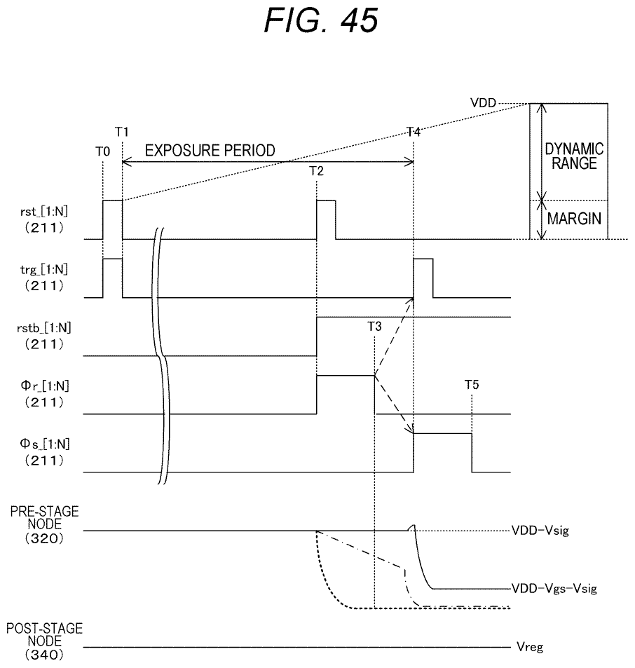

FIG. 45 is a timing chart illustrating an example of a global shutter operation according to the tenth embodiment of the present technology. The method for controlling the transistors at the time of global shutter according to the tenth embodiment is similar to the corresponding method of the first embodiment.

Here, it is assumed that light with very high intensity is incident on the pixel 300. In this case, the photoelectric conversion element 311 becomes full of charges, and the charges overflow from the photoelectric conversion element 311 to the FD 314, resulting in a decrease in the potential of the FD 314 subjected to the FD reset. A long dashed short dashed line in the drawing indicates fluctuations in potential of the FD 314 when weak sunlight that causes a relatively small amount of charges to overflow is incident. A dotted line in the drawing indicates fluctuations in potential of the FD 314 when strong sunlight that causes a relatively large amount of charges to overflow is incident.

When weak sunlight is incident, the reset level is dropping at timing T3 that is the end of the FD reset, but the level has not fully dropped at this point of time.

On the other hand, when strong sunlight is incident, the reset level fully drops at timing T3. In this case, the signal level becomes the same as the reset level, and the potential difference between the signal level and the reset level becomes “0”, so that the digital signal subjected to the CDS processing becomes the same as a digital signal in a dark state and sinks in black. A phenomenon in which the pixel turns black as described above even though light with very high intensity such as sunlight is incident is called a black spot phenomenon or blooming.

Furthermore, when the level of the FD 314 of the pixel in which the black spot phenomenon has occurred is too low, the operating point of the pre-stage circuit 310 cannot be secured, and the current id1 of the current source transistor 316 fluctuates accordingly. The current source transistor 316 of each pixel is connected to a common power supply or ground, so that when a certain pixel suffers fluctuations in current, variations in IR drop in the pixel affect the sample level of another pixel. A pixel in which the black spot phenomenon has occurred turns into an aggressor, and a pixel whose the sample level has fluctuated due to the pixel having the black spot phenomenon turns into a victim. As a result, streaking noise occurs.

Note that, in a case where the discharge transistor 317 is provided as in the seventh embodiment, in a pixel suffering a black spot (blooming), overflowing charges are discharged toward the discharge transistor 317, so that the black spot phenomenon is less likely to occur. However, even if the discharge transistor 317 is provided, some charges may flow to the FD 314, and the black spot phenomenon may be difficult to get rid of completely. Moreover, there is also a disadvantage that the ratio of the effective area/the charge amount in each pixel becomes lower due to the addition of the discharge transistor 317. It is therefore desirable to suppress the black spot phenomenon without the use of the discharge transistor 317.

As a method for preventing the black spot phenomenon without the use of the discharge transistor 317, there are two possible methods. The first method is adjustment of the clip level of the FD 314. The second method is a method in which whether or not the black spot phenomenon has occurred during reading is determined, and when the black spot phenomenon has occurred, the output is replaced with the full code.

Under the first method, the high level of the FD reset signal rst (in other words, the gate of the FD reset transistor 313) in the drawing corresponds to the power supply voltage VDD, and the low level corresponds to the clip level of the FD 314. In the first embodiment, a difference between the high level and the low level (i.e., amplitude) is set to a value corresponding to the dynamic range. In the tenth embodiment, on the other hand, the value is adjusted to a value plus an additional margin. Here, the value corresponding to the dynamic range corresponds to a difference between the power supply voltage VDD and the potential of the FD 314 when the digital signal becomes the full code.

Lowering the gate voltage (the low level of the FD reset signal rst) when the FD reset transistor 313 is off makes it possible to prevent the FD 314 from being excessively lowered due to blooming and the operating point of the pre-stage amplification transistor 315 from being lost.

Note that the dynamic range varies in a manner that depends on the analog gain of the ADC. When the analog gain is low, the dynamic range needs to be wide, and when the analog gain is high, on the other hand, the dynamic range can be narrow. It is therefore possible to change the gate voltage when the FD reset transistor 313 is off in accordance with the analog gain.

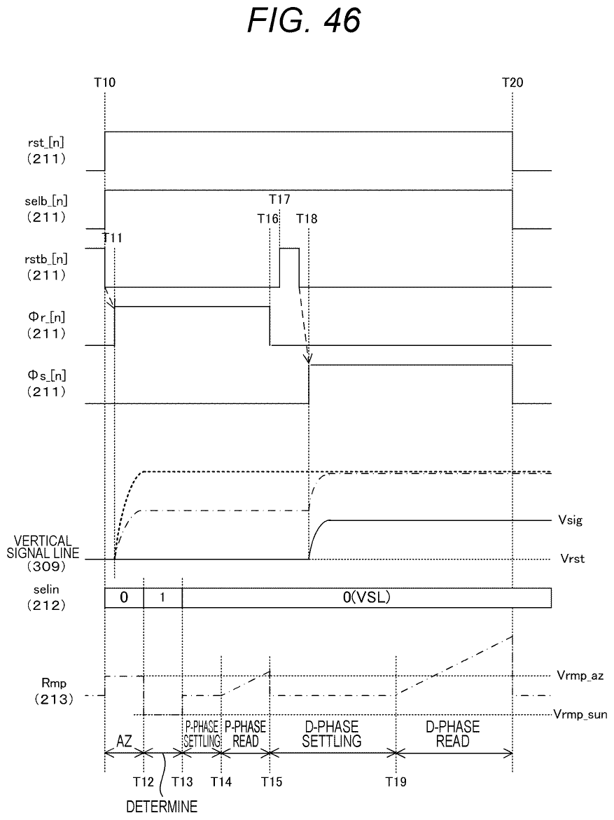

FIG. 46 is a timing chart illustrating an example of a read operation according to the tenth embodiment of the present technology. When the selection signal Φr becomes the high level at timing T11 immediately after timing T10 that is the start of reading, the potential of the vertical signal line 309 fluctuates in the pixel on which sunlight is incident. A long dashed short dashed line in the drawing indicates fluctuations in the potential of the vertical signal line 309 when weak sunlight is incident. A dotted line in the drawing indicates fluctuations in the potential of the vertical signal line 309 when strong sunlight is incident.

In an auto-zero period from timing T10 to timing T12, the control circuit 212 supplies, for example, the input-side selection signal selin of “0” to connect the comparator element 285 to the vertical signal line 309. Within this auto-zero period, the control circuit 212 performs auto-zero using the auto-zero signal Az.

Under the second method, the control circuit 212 supplies, for example, the input-side selection signal selin of “1” within a determination period from timing T12 to timing T13. The input-side selection signal selin disconnects the comparator element 285 from the vertical signal line 309 and connects the comparator element 285 to the node of the reference voltage VREF. The reference voltage VREF is set to the expected value of the level of the vertical signal line 309 when blooming does not occur. For example, when the gate-source voltage of the post-stage amplification transistor 351 is denoted as Vgs2, Vrst corresponds to Vreg-Vgs2. Furthermore, the DAC 213 lowers the level of the ramp signal Rmp from Vrmp_az to Vrmp_sun within the determination period.

Furthermore, in a case where blooming does not occur within the determination period, the reset level Vrst of the vertical signal line 309 is almost the same as the reference voltage VREF, and is not much different from when the potential of the inverting input terminal (+) of the comparator element 285 is auto-zero. On the other hand, since the non-inverting input terminal (−) lowers from Vrmp_az to Vrmp_sun, the comparison result VCO becomes the high level.

Conversely, in a case where blooming occurs, the reset level Vrst becomes sufficiently higher than the reference voltage VREF, and the comparison result VCO becomes the low level when the following expression is established.

$$Vrst - VREF > Vrmp \_ az - Vrmp \_sun \qquad Expression 5$$

That is, the control circuit 212 can determine whether or not blooming has occurred on the basis of whether or not the comparison result VCO becomes the low level within the determination period.

Note that it is necessary to secure some large margin for sun determination (the right side of Expression 5) so as to prevent erroneous determination due to variations in threshold voltage of the post-stage amplification transistor 351, IR drop differences of the in-plane Vreg, or the like.

After timing T13 after the end of the determination period, the control circuit 212 connects the comparator element 285 to the vertical signal line 309. Furthermore, after the end of a P-phase settling period from timing T13 to timing T14, the P-phase is read within a period from timing T14 to timing T15. After the end of a D-phase settling period from timing T15 to timing T19, the D-phase is read within a period from timing T19 to timing T20.

In a case where it is determined that blooming has not occurred over the determination period, the control circuit 212 controls the selector 292 with the output-side selection signal selout to output the digital signal CDS_out subjected to the CDS processing without any change.

On the other hand, in a case where it is determined that blooming has occurred during the determination period, the control circuit 212 controls the selector 292 with the output-side selection signal selout to output the full code FULL instead of the digital signal CDS_out subjected to the CDS processing. It is therefore possible to suppress the black spot phenomenon.

Note that the first to third modification examples of the first embodiment or the second to ninth embodiments can also be applied to the tenth embodiment.

As described above, according to the tenth embodiment of the present technology, since the control circuit 212 determines whether or not the black spot phenomenon has occurred on the basis of the comparison result VCO, and outputs the full code when the black spot phenomenon has occurred, it is possible to suppress the black spot phenomenon.

### 11. Eleventh Embodiment

In the first embodiment described above, the vertical scanning circuit 211 performs control to expose all the rows (all the pixels) simultaneously (i.e., global shutter operation). However, in a case where simultaneous exposure is not required and low noise is demanded during testing or analysis, it is desirable to perform a rolling shutter operation. A solid-state imaging element 200 of this eleventh embodiment is different from the solid-state imaging element 200 of the first embodiment in performing the rolling shutter operation during testing or the like.

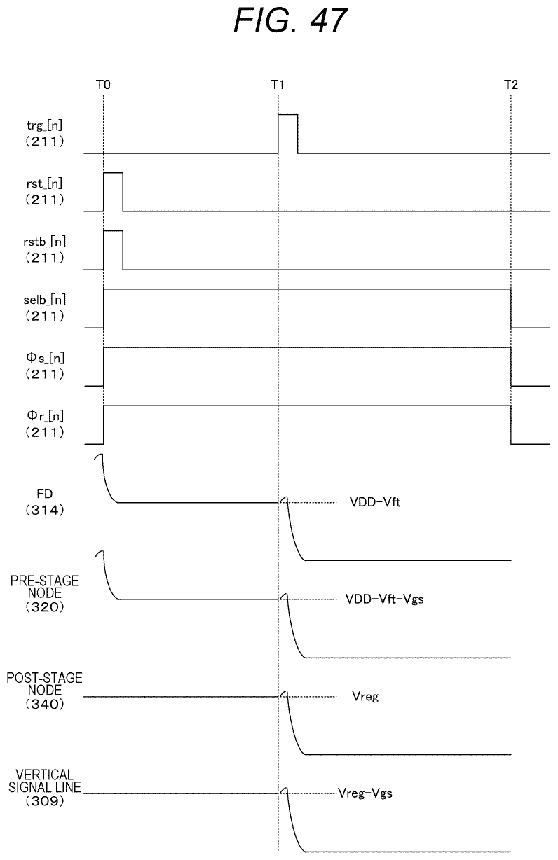

FIG. 47 is a timing chart illustrating an example of the rolling shutter operation according to the eleventh embodiment of the present technology. The vertical scanning circuit 211 performs control to sequentially select a plurality of rows and start exposure. This drawing illustrates exposure control of the n-th row.

Over a period from timing T0 to timing T2, the vertical scanning circuit 211 supplies the high-level post-stage selection signal selb, the high-level selection signal Φr, and the high-level selection signal Φs to the n-th row. Furthermore, at timing T0 that is the start of exposure, the vertical scanning circuit 211 supplies the high-level FD reset signal rst and the high-level post-stage reset signal rstb to the n-th row over the pulse period. At timing T1 that is the end of exposure, the vertical scanning circuit 211 supplies the transfer signal trg to the n-th row. The rolling shutter operation in the drawing allows the solid-state imaging element 200 to generate low-noise image data.

Note that, during normal imaging, the solid-state imaging element 200 of the eleventh embodiment performs the global shutter operation in a manner similar to the first embodiment. Furthermore, the first to third modification examples of the first embodiment or the second to tenth embodiments can also be applied to the eleventh embodiment.

As described above, according to the eleventh embodiment of the present technology, since the vertical scanning circuit 211 performs control to sequentially select a plurality of rows and start exposure (i.e., rolling shutter operation), low-noise image data can be generated.

### 12. Twelfth Embodiment

In the first embodiment described above, the source of the pre-stage source follower (the pre-stage amplification transistor 315 and the current source transistor 316) is connected to the power supply voltage VDD, and row-by-row reading is performed while the source follower is in an on-state. There is, however, a possibility that this driving method causes circuit noise of the pre-stage source follower generated during row-by-row reading to propagate to the subsequent stages, and random noise increases accordingly. A solid-state imaging element 200 of this twelfth embodiment is different from the solid-state imaging element 200 of the first embodiment in that the pre-stage source follower remains in an off-state during reading to reduce noise.

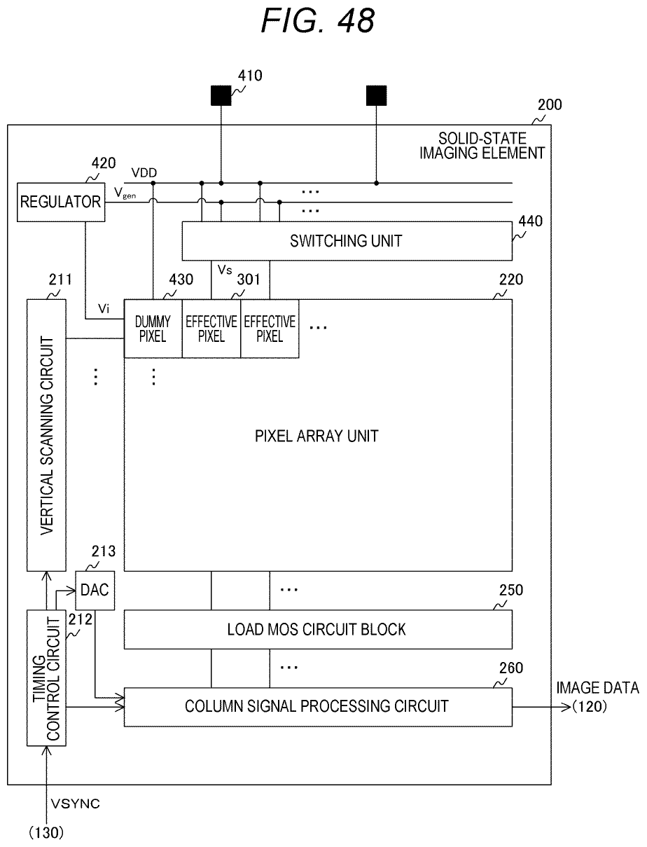

FIG. 48 is a block diagram illustrating a configuration example of the solid-state imaging element 200 according to the twelfth embodiment of the present technology. The solid-state imaging element 200 of the twelfth embodiment is different from the solid-state imaging element 200 of the first embodiment in that a regulator 420 and a switching unit 440 are further provided. In the drawing, the communication interfaces 214 and 215 are not illustrated. Furthermore, the pixel array unit 220 of the twelfth embodiment has an array of a plurality of effective pixels 301 and a predetermined number of dummy pixels 430. The dummy pixels 430 are arranged around a region in which the effective pixels 301 are arranged.

Furthermore, the power supply voltage VDD is supplied to each of the dummy pixels 430, and the power supply voltage VDD and a source voltage Vs are supplied to each of the effective pixels 301. A signal line through which the power supply voltage VDD is supplied to the effective pixels 301 is not illustrated in the drawing. Furthermore, the power supply voltage VDD is supplied from a pad 410 located outside the solid-state imaging element 200.

The regulator 420 generates a constant generation voltage Vgen on the basis of an input voltage Vi received from the dummy pixels 430, and supplies the generation voltage Vgen to the switching unit 440. The switching unit 440 selects either the power supply voltage VDD received from the pad 410 or the generation voltage Vgen received from the regulator 420, and supplies the selected voltage as the source voltage Vs to each of the columns of the effective pixels 301.

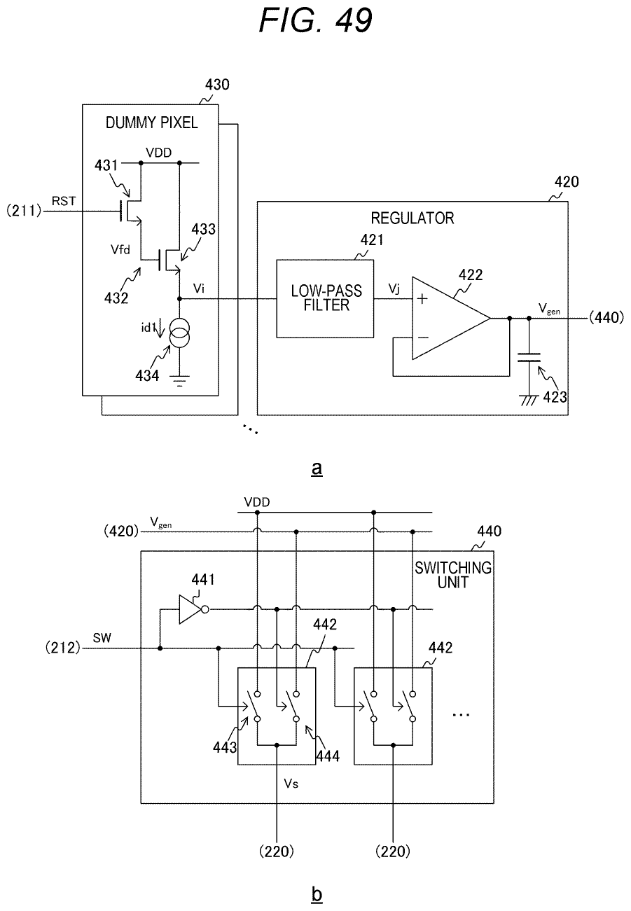

FIG. 49 is a circuit diagram illustrating a configuration example of the dummy pixel 430, the regulator 420, and the switching unit 440 according to the twelfth embodiment of the present technology. Of the drawing, a is a circuit diagram of the dummy pixel 430 and the regulator 420, and b is a circuit diagram of the switching unit 440.

As illustrated in a of the drawing, the dummy pixel 430 includes a reset transistor 431, an FD 432, an amplification transistor 433, and a current source transistor 434. The reset transistor 431 initializes the FD 432 in accordance with a reset signal RST received from the vertical scanning circuit 211. The FD 432 accumulates charges, and generates a voltage corresponding to the amount of charges. The amplification transistor 433 amplifies a level of the voltage of the FD 432 and supplies the amplified voltage as the input voltage Vi to the regulator 420.

Furthermore, the reset transistor 431 and the amplification transistor 433 have their respective sources connected to the power supply voltage VDD. The current source transistor 434 is connected to a drain of the amplification transistor 433. The current source transistor 434 supplies the current id1 under the control of the vertical scanning circuit 211.

The regulator 420 includes a low-pass filter 421, a buffer amplifier 422, and a capacitor element 423. The low-pass filter 421 passes, as an output voltage Vj, a component of a signal of the input voltage Vi in a low-frequency band below a predetermined frequency.

The output voltage Vj is input to a non-inverting input terminal (+) of the buffer amplifier 422. The buffer amplifier 422 has an inverting input terminal (−) connected to an output terminal thereof. The capacitor element 423 holds a voltage of the output terminal of the buffer amplifier 422 as Vgen. This Vgen is supplied to the switching unit 440.

As illustrated in b of the drawing, the switching unit 440 includes an inverter 441 and a plurality of switching circuits 442. The switching circuits 442 are arranged on a one-to-one basis for the columns of the effective pixels 301.

The inverter 441 inverts a switching signal SW received from the control circuit 212. The inverter 441 supplies the inverted signal to each of the switching circuits 442.

Each switching circuit 442 selects either the power supply voltage VDD or the generation voltage Vgen, and supplies the selected voltage as the source voltage Vs to the corresponding column in the pixel array unit 220. The switching circuit 442 includes switches 443 and 444. The switch 443 opens and closes a path between the node of the power supply voltage VDD and the corresponding column in accordance with the switching signal SW. The switch 444 opens and closes a path between the node of the generation voltage Vgen and the corresponding column in accordance with an inverted signal of the switching signal SW.

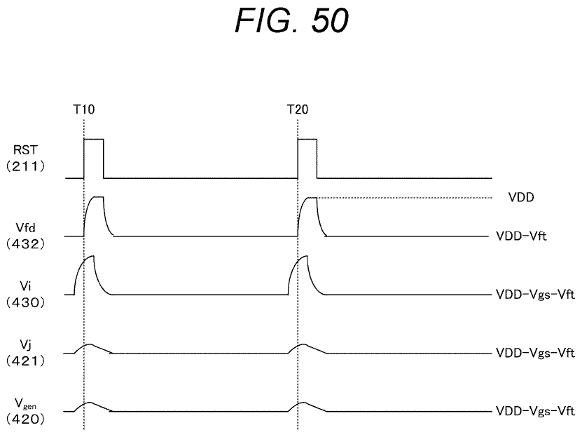

FIG. 50 is a timing chart illustrating an example of how the dummy pixel 430 and the regulator 420 according to the twelfth embodiment of the present technology operate. At timing T10 immediately before reading of a certain row, the vertical scanning circuit 211 supplies the high-level reset signal RST (the power supply voltage VDD herein) to each of the dummy pixels 430. A potential Vfd of the FD 432 in each dummy pixel 430 is initialized to the power supply voltage VDD. Then, when the reset signal RST becomes the low level, reset feedthrough causes a change to VDD-Vft.

Furthermore, the input voltage Vi decreases to VDD-Vgs-Vft after the reset. Passing through the low-pass filter 421 makes Vj and Vgen almost constant.

After timing T20 immediately before reading of the next row, similar control is performed for each row, and the constant generation voltage Vgen is supplied.

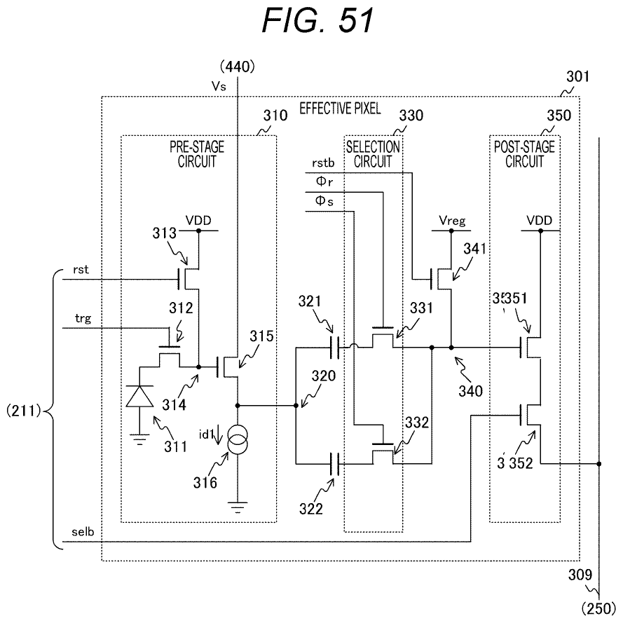

FIG. 51 is a circuit diagram illustrating a configuration example of the effective pixel 301 according to the twelfth embodiment of the present technology. The effective pixel 301 is similar in circuit configuration to the pixel 300 of the first embodiment, except that the source voltage Vs from the switching unit 440 is supplied to the source of the pre-stage amplification transistor 315.

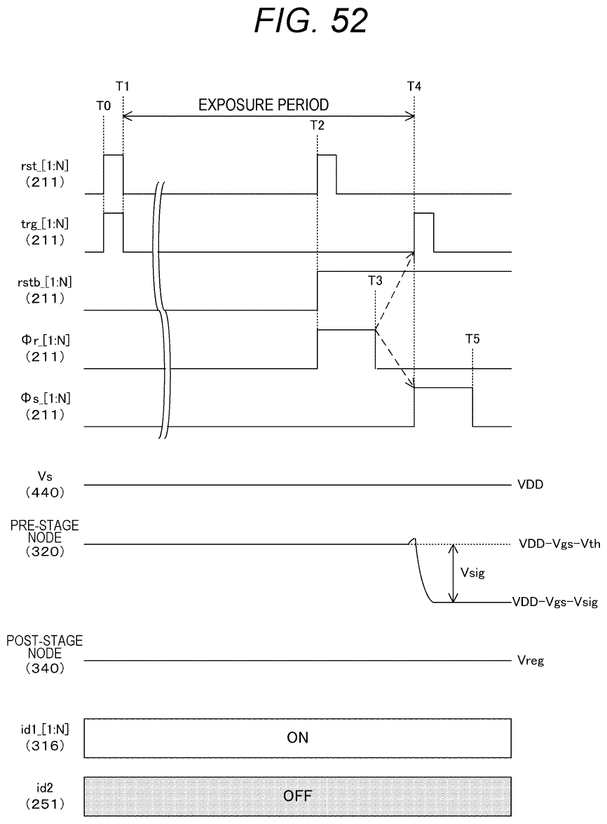

FIG. 52 is a timing chart illustrating an example of a global shutter operation according to the twelfth embodiment of the present technology. In the twelfth embodiment, when all the pixels are exposed simultaneously, the switching unit 440 selects the power supply voltage VDD, and supplies the power supply voltage VDD as the source voltage Vs. Furthermore, the voltage of the pre-stage node decreases from VDD-Vgs-Vth to VDD-Vgs-Vsig at timing T4. Here, Vth represents a threshold voltage of the transfer transistor 312.

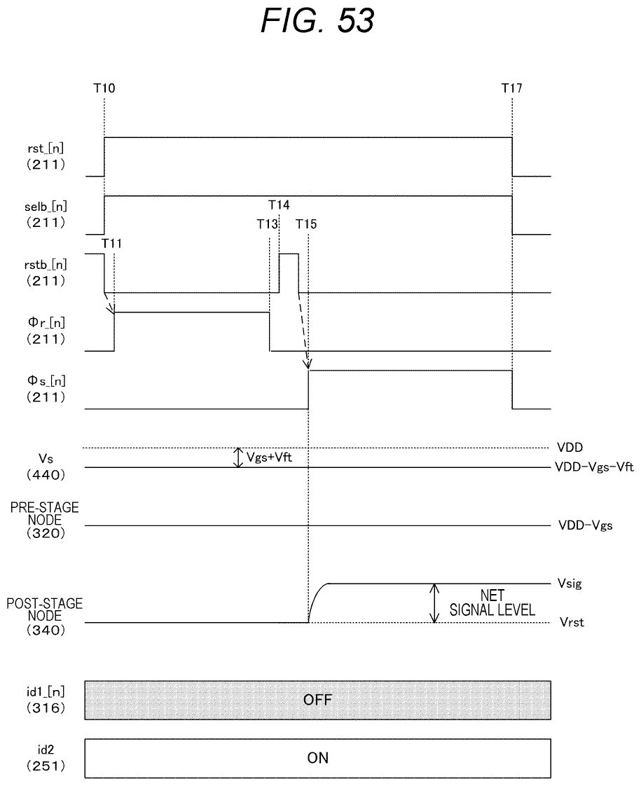

FIG. 53 is a timing chart illustrating an example of a read operation according to the twelfth embodiment of the present technology. In the twelfth embodiment, at the time of reading, the switching unit 440 selects the generation voltage Vgen, and supplies the generation voltage Vgen as the source voltage Vs. The generation voltage Vgen is adjusted to VDD-Vgs-Vft. Furthermore, in the twelfth embodiment, the vertical scanning circuit 211 controls the current source transistors 316 of all the rows (all the pixels) to interrupt the supply of the current id1.

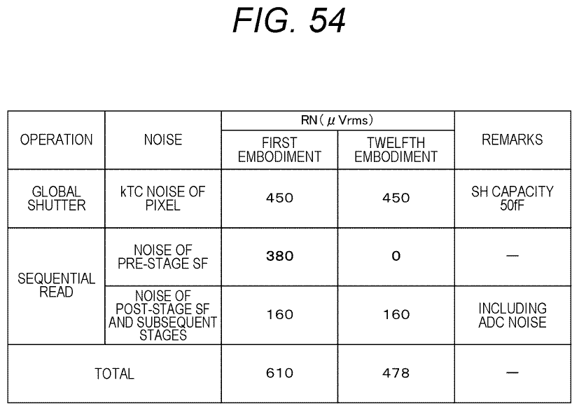

FIG. 54 is a diagram for describing effects according to the twelfth embodiment of the present technology. In the first embodiment, the source follower (the pre-stage amplification transistor 315 and the current source transistor 316) of the pixel 300 subject to reading is turned on during the row-by-row reading. There is, however, a possibility that this driving method causes circuit noise of the pre-stage source follower to propagate to the subsequent stages (the capacitor element, the post-stage source follower, and the ADC), and readout noise increases accordingly.

For example, in the first embodiment, kTC noise generated in a pixel during the global shutter operation is 450 (μVrms) as shown in the drawing. Furthermore, noise generated in the pre-stage source follower (the pre-stage amplification transistor 315 and the current source transistor 316) during row-by-row reading is 380 (μVrms). Noise generated in the post-stage source follower and the subsequent stages is 160 (μVrms). Therefore, the total noise is 610 (μVrms). As described above, in the first embodiment, a proportion of the noise of the pre-stage source follower in the total noise becomes relatively large.

To reduce the noise of the pre-stage source follower in the twelfth embodiment, the voltage (Vs) that can be adjusted is supplied to the source of the pre-stage source follower as described above. During the global shutter (exposure) operation, the switching unit 440 selects the power supply voltage VDD and supplies the power supply voltage VDD as the source voltage Vs. Then, after the end of exposure, the switching unit 440 switches the source voltage Vs to VDD-Vgs-Vft. Furthermore, the control circuit 212 turns on the pre-stage current source transistor 316 during the global shutter (exposure) operation, and turns off the pre-stage current source transistor 316 after the end of exposure.

As illustrated in FIGS. 52 and 53, the above-described control equalizes the potential of the pre-stage node between the global shutter operation and the row-by-row reading, and thus allows an improvement in PRNU. Furthermore, since the pre-stage source follower is in the off state during the row-by-row reading, circuit noise of the source follower does not occur and becomes zero (μVrms) as shown in FIG. 54. Note that, in the pre-stage source follower, the pre-stage amplification transistor 315 is in the on-state.

As described above, according to the twelfth embodiment of the present technology, since the pre-stage source follower is in the off-state during reading, the noise generated in the source follower can be reduced.

### 13. Example of Application to Mobile Body

The technology according to the present disclosure (the present technology) can be applied to various products. For example, the technology according to the present disclosure may be implemented as a device mounted on any type of mobile body such as an automobile, an electric vehicle, a hybrid electric vehicle, a motorcycle, a bicycle, a personal mobility, an airplane, a drone, a vessel, and a robot.

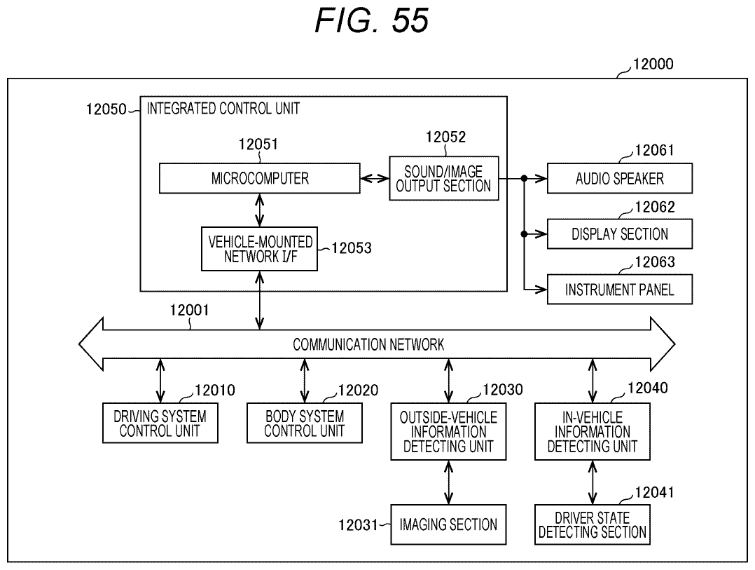

FIG. 55 is a block diagram illustrating a schematic configuration example of a vehicle control system that is an example of a mobile body control system to which the technology according to the present disclosure may be applied.

The vehicle control system 12000 includes a plurality of electronic control units connected to each other via a communication network 12001. In the example illustrated in FIG. 55, the vehicle control system 12000 is provided with a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 55, as the output device, an audio speaker 12061, a display section 12062, and an instrument panel 12063 are illustrated. The display section 12062 may, for example, include at least one of an on-board display and a head-up display.

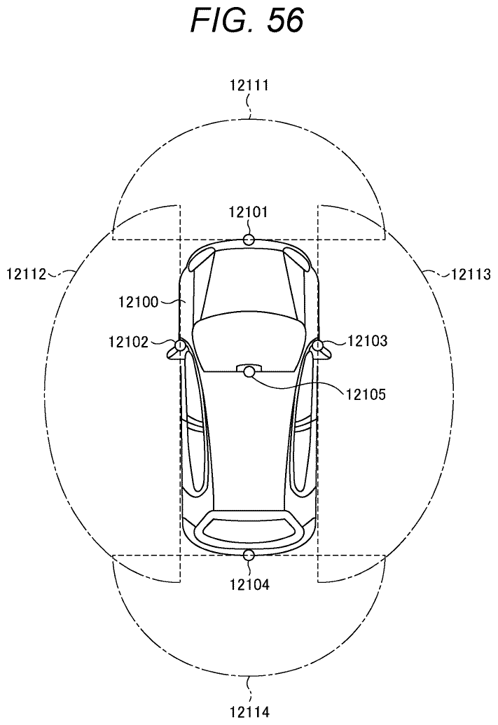

FIG. 56 is a diagram illustrating an example of an installation position of the imaging section 12031.

In FIG. 56, the imaging section 12031 includes imaging sections 12101, 12102, 12103, 12104, and 12105.

The imaging sections 12101, 12102, 12103, 12104, 12105 are provided, for example, at positions such as a front nose, sideview mirrors, a rear bumper, a back door, and an upper portion of a windshield in the interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtains mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that, FIG. 56 illustrates examples of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure may be applied has been described above. The technology according to the present disclosure may be applied to the imaging section 12031 among the configurations described above. Specifically, the solid-state imaging element 200 in FIG. 1 can be applied to the imaging section 12031, for example. Applying the technology according to the present disclosure to the imaging section 12031 allows an improvement in system usability.

Note that the embodiments described above show examples for embodying the present technology, and the respective matters in the embodiments and the respective matters specifying the invention in the claims have correspondence relationships. Similarly, the matters specifying the invention in the claims and the matters with the same names in the embodiments of the present technology have correspondence relationships. However, the present technology is not limited to the embodiments, and can be embodied by applying various modifications to the embodiments without departing from the scope of the present technology.

Note that the effects described herein are merely examples and are not limited, and other effects may also be achieved.

Note that the present technology may also have the following configuration.

(1) A solid-state imaging element including:
a pixel array unit with an array of a plurality of pixels, each of the plurality of pixels being configured to generate a pixel signal and sample and hold the pixel signal;
a vertical scanning circuit that drives each of a plurality of rows in the pixel array unit to output the pixel signal;
a signal processing circuit that reads the pixel signal and performs predetermined signal processing on the pixel signal; and
a control circuit that controls at least one of the vertical scanning circuit or the signal processing circuit to generate compressed data by compressing image data with an array of the pixel signals, and controls at least one of the vertical scanning circuit or the signal processing circuit on the basis of a result of processing the compressed data to output cutout data, the cutout data corresponding to a predetermined region cut out from the image data.

(2) The solid-state imaging element according to the above (1), in which
the control circuit generates data by thinning out the image data on at least one of a row-by-row basis or a column-by-column basis as the compressed data.

(3) The solid-state imaging element according to the above (1), in which
the signal processing circuit includes a compression processing unit that generates the compressed data by pixel addition.

(4) The solid-state imaging element according to the above (3), in which
the signal processing circuit further includes a plurality of analog to digital converters that each converts the pixel signal into a digital signal,
the pixel signal includes an analog signal, and
the compression processing unit generates the compressed data by adding the digital signals.

(5) The solid-state imaging element according to the above (3), in which
the signal processing circuit further includes a plurality of analog to digital converters that each converts the pixel signal into a digital signal,
the pixel signal includes an analog signal, and
the compression processing unit generates the compressed data by adding the pixel signals.

(6) The solid-state imaging element according to any one of the above (1) to (5), further including a detection processing unit that performs predetermined detection processing on the compressed data.

(7) The solid-state imaging element according to the above (6), in which
the signal processing circuit outputs the result of the processing to an outside of the solid-state imaging element.

(8) The solid-state imaging element according to the above (6), in which
the detection processing unit detects whether or not a face is present.

(9) The solid-state imaging element according to the above (6), in which
the detection processing unit detects whether or not a person is present.

(10) The solid-state imaging element according to the above (6), in which
the detection processing unit detects a difference between the compressed data and predetermined background data.

(11) The solid-state imaging element according to the above (1), further including a communication interface that receives the result of the processing and supplies the result to the control circuit.

(12) The solid-state imaging element according to any one of the above (1) to (11), in which
the pixel signal includes a predetermined reset level and a signal level corresponding to an exposure amount, and
each of the plurality of pixels includes:
first and second capacitor elements;
a pre-stage circuit that sequentially generates the reset level and the signal level and causes the first and second capacitor elements to hold the reset level and the signal level, respectively;
a selection circuit that sequentially performs control to connect one of the first and second capacitor elements to a predetermined post-stage node, control to disconnect both of the first and second capacitor elements from the post-stage node, and control to connect another one of the first and second capacitor elements to the post-stage node; and
a post-stage reset transistor that initializes a level of the post-stage node when both of the first and second capacitor elements are disconnected from the post-stage node; and
a post-stage circuit that sequentially reads the reset level and the signal level from the first and second capacitor elements via the post-stage node and outputs the reset level and the signal level.

(13) An imaging system including:
a solid-state imaging element including: a pixel array unit having an array of a plurality of pixels, each of the plurality of pixels being configured to generate a pixel signal and sample and hold the pixel signal; a vertical scanning circuit that drives each of a plurality of rows in the pixel array unit to output the pixel signal; a signal processing circuit that reads the pixel signal and performs predetermined signal processing on the pixel signal; and a control circuit that controls at least one of the vertical scanning circuit or the signal processing circuit to generate compressed data by compressing image data containing an array of the pixel signals, and controls at least one of the vertical scanning circuit or the signal processing circuit on the basis of a result of processing the compressed data to output cutout data, the cutout data corresponding to a predetermined region cut out from the image data; and
a host that performs processing different from the processing on the basis of the cutout data.

(14) A method for controlling a solid-state imaging element, the method including:
a vertical scanning step for causing a vertical scanning circuit to drive each of a plurality of rows in a pixel array unit having an array of a plurality of pixels, each of the plurality of pixels being configured to generate a pixel signal and sample and hold the pixel signal, to output the pixel signal;
a signal processing step for causing a signal processing circuit to read the pixel signal and perform predetermined signal processing on the pixel signal; and
a controlling step for controlling at least one of the vertical scanning circuit or the signal processing circuit to generate compressed data by compressing image data containing an array of the pixel signals, and controlling at least one of the vertical scanning circuit or the signal processing circuit on the basis of a result of processing the compressed data to output cutout data, the cutout data corresponding to a predetermined region cut out from the image data.

### REFERENCE SIGNS LIST

100 Imaging system
110 Host
111, 112 Communication interface
113 Database
114 Authentication processing unit
115 Imaging control unit
116, 265 Detection processing unit
117, 266 Cutout region calculation unit
118 Action determination unit
150 Imaging device
200 Solid-state imaging element
201 Pixel chip
202 Circuit chip
203 Upper pixel chip
204 Lower pixel chip
211 Vertical scanning circuit
212 Control circuit
213 DAC
214, 215 Communication interface
220 Pixel array unit
221 Upper pixel array unit
222 Lower pixel array unit
250 Load MOS circuit block
251 Load MOS transistor
260 Column signal processing circuit
261, 264 Compression processing unit
262 Data processing unit
263 Demultiplexer
270 ADC
271 Counter
280 Comparator
281, 292 Selector
282, 283, 321, 322, 423 Capacitor element
284, 286 Auto-zero switch
285 Comparator element
291 CDS processing unit
300 Pixel
301 Effective pixel
310 Pre-stage circuit
311 Photoelectric conversion element
312 Transfer transistor
313 FD reset transistor
314, 432 FD
315 Pre-stage amplification transistor
316, 434 Current source transistor
317 Discharge transistor
323 Pre-stage reset transistor
324 Pre-stage selection transistor
330 Selection circuit
331, 332 Selection transistor
341 Post-stage reset transistor
350 Post-stage circuit
351 Post-stage amplification transistor
352 Post-stage selection transistor
420 Regulator
421 Low-pass filter
422 Buffer amplifier
430 Dummy pixel
431 Reset transistor
433 Amplification transistor
440 Switching unit
441 Inverter
442 Switching circuit
443, 444 Switch
12031 Imaging section

1. A solid-state imaging element comprising:
a pixel array unit having an array of a plurality of pixels, each of the plurality of pixels being configured to generate a pixel signal and sample and hold the pixel signal;
a vertical scanning circuit that drives each of a plurality of rows in the pixel array unit to output the pixel signal;
a signal processing circuit that reads the pixel signal and performs predetermined signal processing on the pixel signal; and
a control circuit that controls at least one of the vertical scanning circuit or the signal processing circuit to generate compressed data by compressing image data containing an array of the pixel signals, and controls at least one of the vertical scanning circuit or the signal processing circuit on a basis of a result of processing the compressed data to output cutout data, the cutout data corresponding to a predetermined region cut out from the image data.

2. The solid-state imaging element according to claim 1, wherein
the control circuit generates data by thinning out the image data on at least one of a row-by-row basis or a column-by-column basis as the compressed data.

3. The solid-state imaging element according to claim 1, wherein
the signal processing circuit includes a compression processing unit that generates the compressed data by pixel addition.

4. The solid-state imaging element according to claim 3, wherein
the signal processing circuit further includes a plurality of analog to digital converters that each converts the pixel signal into a digital signal,
the pixel signal includes an analog signal, and
the compression processing unit generates the compressed data by adding the digital signals.

5. The solid-state imaging element according to claim 3, wherein
the signal processing circuit further includes a plurality of analog to digital converters that each converts the pixel signal into a digital signal,
the pixel signal includes an analog signal, and
the compression processing unit generates the compressed data by adding the pixel signals.

6. The solid-state imaging element according to claim 1, further comprising a detection processing unit that performs predetermined detection processing on the compressed data.

7. The solid-state imaging element according to claim 6, wherein
the signal processing circuit outputs the result of the processing to an outside of the solid-state imaging element.

8. The solid-state imaging element according to claim 6, wherein
the detection processing unit detects whether or not a face is present.

9. The solid-state imaging element according to claim 6, wherein
the detection processing unit detects whether or not a person is present.

10. The solid-state imaging element according to claim 6, wherein
the detection processing unit detects a difference between the compressed data and predetermined background data.

11. The solid-state imaging element according to claim 1, further comprising a communication interface that receives the result of the processing and supplies the result to the control circuit.

12. The solid-state imaging element according to claim 1, wherein
the pixel signal includes a predetermined reset level and a signal level corresponding to an exposure amount, and
each of the plurality of pixels includes:
first and second capacitor elements;
a pre-stage circuit that sequentially generates the reset level and the signal level and causes the first and second capacitor elements to hold the reset level and the signal level, respectively;
a selection circuit that sequentially performs control to connect one of the first and second capacitor elements to a predetermined post-stage node, control to disconnect both of the first and second capacitor elements from the post-stage node, and control to connect another one of the first and second capacitor elements to the post-stage node;
a post-stage reset transistor that initializes a level of the post-stage node when both of the first and second capacitor elements are disconnected from the post-stage node; and
a post-stage circuit that sequentially reads the reset level and the signal level from the first and second capacitor elements via the post-stage node and outputs the reset level and the signal level.

13. An imaging system comprising:
a solid-state imaging element including: a pixel array unit having an array of a plurality of pixels, each of the plurality of pixels being configured to generate a pixel signal and sample and hold the pixel signal; a vertical scanning circuit that drives each of a plurality of rows in the pixel array unit to output the pixel signal; a signal processing circuit that reads the pixel signal and performs predetermined signal processing on the pixel signal; and a control circuit that controls at least one of the vertical scanning circuit or the signal processing circuit to generate compressed data by compressing image data containing an array of the pixel signals, and controls at least one of the vertical scanning circuit or the signal processing circuit on a basis of a result of processing the compressed data to output cutout data, the cutout data corresponding to a predetermined region cut out from the image data; and
a host that performs processing different from the processing on a basis of the cutout data.

14. A method for controlling a solid-state imaging element, the method comprising:
a vertical scanning step for causing a vertical scanning circuit to drive each of a plurality of rows in a pixel array unit having an array of a plurality of pixels, each of the plurality of pixels being configured to generate a pixel signal and sample and hold the pixel signal, to output the pixel signal;
a signal processing step for causing a signal processing circuit to read the pixel signal and perform predetermined signal processing on the pixel signal; and
a controlling step for controlling at least one of the vertical scanning circuit or the signal processing circuit to generate compressed data by compressing image data containing an array of the pixel signals, and controlling at least one of the vertical scanning circuit or the signal processing circuit on a basis of a result of processing the compressed data to output cutout data, the cutout data corresponding to a predetermined region cut out from the image data.
